(19) United States
(12) Patent Application Publication
(10) Pub. No.: US 2003/0182215 A1
(43) Pub. Date: Sep. 25, 2003

(54) Network-enabled method and system for asset finance

(76) Inventors: Peter Ringler, Montreal (CA); Jeffrey Hawkins, Mississauga (CA)

Correspondence Address: Jonh S. Beulick, Armstrong Teasdale LLP, Suite 2600, One Metropolitan Sq., St. Louis, MO, 63102, US

(21) Appl. No.: 10/103,067

(22) Filed: Mar. 20, 2002

(51) Int. Cl. G06F 17/60

(52) U.S. Cl. 705/35

(57) ABSTRACT

A method for processing asset finance applications uses a web-enabled asset finance system including a web-based front end, a business logic middle tier, a credit scoring engine, and a relational database. The method includes receiving information from a user device via the web-based front end, utilizing the business logic middle tier to supply the received information to the relational database, processing the received information to supply a finance quote, and transmitting the processed information to the user device.

### BACKGROUND OF THE INVENTION

This invention relates generally to network based systems and methods and more particularly to network-enabled methods and systems for managing functions related to asset financing and credit history.

Typically, asset finance applications are paper-based transactions that involve sending documents to multiple locations. These transactions typically have long cycle times. In addition, a finance company often targets particular markets with unique needs and characteristics. Thus it is sometimes difficult for a finance company to provide a custom-tailored on-line system for processing finance transactions. In addition, it may not be an easy task for an asset finance company to enter new markets with new marketing programs.

### BRIEF DESCRIPTION OF THE INVENTION

In one aspect, a method for processing asset finance applications uses a web-enabled asset finance system including a web-based front end, a business logic middle tier, a credit scoring engine, and a relational database. The method comprises receiving information from a user device via the web-based front end, utilizing the business logic middle tier to supply the received information to the relational database, processing the received information to supply a finance quote, and transmitting the processed information to the user device.

In another aspect, a network-enabled asset finance system includes a network-based front end, a business logic middle tier linked to the frontend, a credit scoring engine linked to the business logic middle tier, and a relational database linked to the business logic middle tier. The business logic middle tier is configured to receive information from a user device via the network-based front end, supply the received information to the relational database, receive processed information from the credit scoring engine, and transmit the processed information to the user device.

In a further aspect, a method is provided for processing asset finance applications on a web-site using an asset finance system including a web-based front end, a business logic middle tier, a credit scoring engine, and a relational database. The method comprises receiving information from a user device via the web-based front end, accessing the business logic middle tier to supply the received information to the relational database, processing the received information to supply at least one of a credit application decision and a finance quote, and transmitting the processed information to the user device.

In another aspect, a computer program embodied on a computer readable medium is provided for analyzing a credit application input by a user on a web site to determine whether to accept the application. The program comprises a code segment that receives credit application information and reviews the input information to determine whether all required information has been included, scores the credit application to determine whether to accept the credit application, determines whether an instant credit decision can be made, and notifies the user of the credit application acceptance decision.

A network-enabled asset finance system comprising a network-based front end, a business logic middle tier linked to the front-end, a credit scoring engine linked to the business logic middle tier, and a relational database linked to the business logic middle tier. The business logic middle tier configured to receive information from a user device via the network-based front end, supply the received information to the relational database, receive processed information from the credit scoring engine, and generate documentation for the transaction.

### BRIEF DESCRIPTION OF THE DRAWINGS

FIG. 1 is a simplified block diagram of an exemplary Asset Finance System;

FIG. 2 is a more detailed block diagram and hardware configuration of the Asset Finance System shown in FIG. 1;

FIG. 3 is a block diagram of an exemplary application architecture for the Asset Finance System shown in FIG. 1;

FIG. 4 is a workflow diagram of a method of managing asset financing and credit history.

FIG. 5 is an exemplary embodiment of a user interface displaying a login page of the Asset Finance System shown in FIG. 1.

FIG. 6 is a user interface displaying a home page of the Asset Finance System shown in FIG. 1.

FIG. 7 is a user interface displaying a Compare Payments page of the Asset Finance System shown in FIG. 1.

FIG. 8 is a user interface displaying a Finance Quote main page of the Asset Finance System shown in FIG. 1.

FIG. 9 is a user interface displaying a New Commercial Customer Profile page of the Asset Finance System shown in FIG. 1.

FIG. 10 is a user interface displaying a Bank and Insurance Information page of the Asset Finance System shown in FIG. 1.

FIG. 11 is a user interface displaying a New Individual Customer Profile page of the Asset Finance System shown in FIG. 1.

FIG. 12 is a user interface displaying a first portion of an Employment/Financial Information page of the Asset Finance System shown in FIG. 1.

FIG. 13 is a user interface displaying a Personal Net Worth Statement page of the Asset Finance System shown in FIG. 1.

FIG. 14 is a user interface displaying a Build Your Finance Quote page of the Asset Finance System shown in FIG. 1.

FIG. 15 is a user interface displaying an Enter Quotation Information page of the Asset Finance System shown in FIG. 1.

FIG. 16 is a user interface displaying a Payment Calculation page of the Asset Finance System shown in FIG. 1.

FIG. 17 is a user interface displaying a Retrieving Saved Quote page of the Asset Finance System shown in FIG. 1.

FIG. 18 is a user interface displaying a Credit Application Main Page of the Asset Finance System shown in FIG. 1.

FIG. 19 is a user interface displaying a New Commercial Customer Profile page of the Asset Finance System shown in FIG. 1.

FIG. 20 is a user interface displaying a Bank and Insurance Information page of the Asset Finance System shown in FIG. 1.

FIG. 21 is a user interface displaying a New Individual Customer Profile page of the Asset Finance System shown in FIG. 1.

FIG. 22 is a user interface displaying a first portion of an Employment/Financial Information page of the Asset Finance System shown in FIG. 1.

FIG. 23 is a user interface displaying a second portion of an Employment/Financial Information page of the Asset Finance System shown in FIG. 1.

FIG. 24 is a user interface displaying a Build Your Credit Application page of the Asset Finance System shown in FIG. 1.

FIG. 25 is a user interface displaying a Main Applicant Information page of the Asset Finance System shown in FIG. 1.

FIG. 26 is a continuation of the user interface shown in FIG. 25 displaying a Main Applicant Information page of the Asset Finance System shown in FIG. 1.

FIG. 27 is a user interface displaying an Employment/Financial Information page of the Asset Finance System shown in FIG. 1.

FIG. 28 is a user interface displaying a Personal Net Worth Statement page of the Asset Finance System shown in FIG. 1.

FIG. 29 is a user interface displaying an Equipment Information page of the Asset Finance System shown in FIG. 1.

FIG. 30 is a user interface displaying a Deal Structure page of the Asset Finance System shown in FIG. 1.

FIG. 31 is a user interface displaying a Credit Submission page of the Asset Finance System shown in FIG. 1.

FIG. 32 is a user interface displaying a Request Deal Change page of the Asset Finance System shown in FIG. 1.

FIG. 33 is a user interface displaying a printable version of the application available through the Asset Finance System shown in FIG. 1.

FIG. 34 is a user interface displaying a Search for Dealer Participation page of the Asset Finance System shown in FIG. 1.

FIG. 35 is a user interface displaying a Finance & Insurance Search Screen page of the Asset Finance System shown in FIG. 1.

FIG. 36 is a user interface 920 displaying a Report Output page of the Asset Finance System shown in FIG. 1.

FIG. 37 is a user interface displaying a Dealer Default Input page of the Asset Finance System shown in FIG. 1.

### DETAILED DESCRIPTION OF THE INVENTION

Exemplary embodiments of systems and processes that facilitate integrated web-enabled asset financing are described below in detail. In one embodiment, the system includes a web-based front end, a configurable business logic middle tier, a credit scoring tool, a documentation generation utility and a relational database. The systems and processes facilitate, for example, electronic submission of finance applications from dealers and end-customers using a client device, automated transmission of information, and web-enabled customer quote generation, credit application receipt and review, and document generation.

More specifically, data relating to a finance application is entered into the system by a user, such as a sales person. The pricing program information and dealer profiles are maintained internally by the financier. Using the equipment information and the payment options, a payment schedule is generated by the system. The customer's credit history is checked and a credit score is generated to determine whether the finance application should be approved. Once approved, the dealer can use the system to generate the documents required for the deal.

The systems and processes are not limited to the specific embodiments described herein. In addition, system and process components can be practiced independent and separate from other components described herein. Also, each component can be used in combination with other components. Further, one or more components can be external to the system and accessible by the system to create a seamless virtual system. In one embodiment, the technical effect of the system is to provide for a digitized process to facilitate managing functions related to asset financing and credit history.

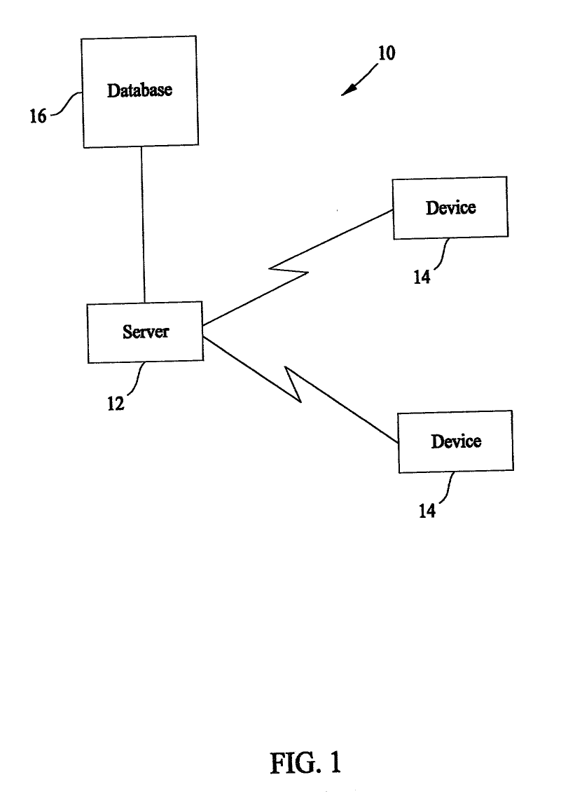

FIG. 1 is a simplified block diagram of an exemplary Asset Finance System 10 including a server system 12 and a plurality of devices 14 connected to server system 12. In one embodiment, devices 14 are computers including a web browser, and server system 12 is accessible to devices 14 via the Internet. Alternatively, devices 14 are any device capable of interconnecting to the Internet including a web-enabled phone, personal digital assistant (PDA), or other web-enabled connectable equipment. Devices 14 are interconnected to the Internet through many interfaces including a network, such as a local area network (LAN) or a wide area network (WAN), dial-in-connections, cable modems and high-speed connections.

System 10 utilizes a web-enabled database 16 to automate asset finance processes. In one exemplary embodiment, system 10 utilizes a Relational Database with a web interface for user input and reports. Information is accessed in the database through Structured Query Language (SQL). In one embodiment, database 16 is centralized and is stored on server system 12 through one of client systems 14. In an alternative embodiment, database 16 is stored remotely from server system 12 and is non-centralized.

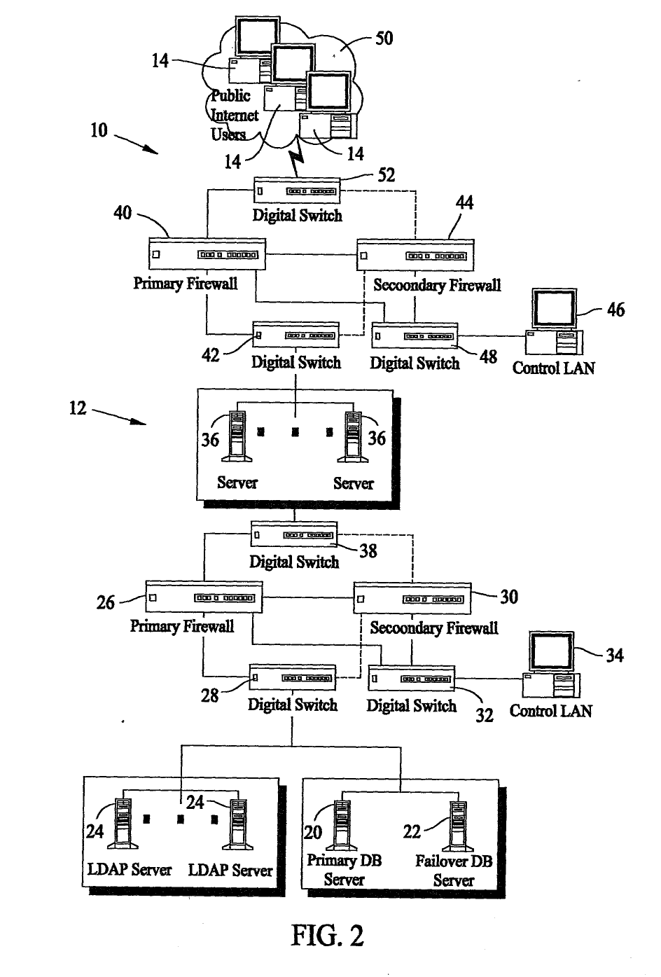

FIG. 2 is a more detailed block diagram of exemplary Asset Finance System 10 illustrating a server architecture for server system 12. Server system 12 includes a primary database server 20 including a data storage device (not shown) and a fail-over database server 22 including a data storage device (not shown). Fail-over server 22, in one embodiment, is utilized as a gateway server which provides performance gains and. fail-over for connections to the system applications. The data storage devices are utilized for storing SQL databases and membership & Web databases. In addition, server system 12 includes multiple LDAP servers 24 which perform Windows Load Balancing Services. Servers 24 perform various functions including user/member authentication services. The configuration of servers 24 through the use of Windows Load Balancing Services supports ease of scaling by allowing additional web servers to be added to the cluster of servers 24. In an exemplary embodiment, servers 24 are dedicated to servicing web pages, both static and dynamic, thus providing for performance enhancements over multi-tasked servers.

Servers 20, 22, and 24 are connected to a first primary firewall 26 through a first digital switch 28. In addition, servers 20, 22, and 24 are connected to a secondary firewall 30 through a second digital switch 32. In an alternative embodiment, servers 20, 22, and 24 are connected to secondary firewall 30 through primary firewall 26. A control LAN management station 34 is connected to primary firewall 26 and secondary firewall 30 through second digital switch 32. Primary firewall 26 includes a SQL server port, a LDAP server port, a MSDTC server port, and an optional SMTP server port.

Firewalls 26 and 30 are connected to at least one IIS & MTS/COM server 36 through a third digital switch 38. IIS & MTS/COM servers 36 store a series of business logic COM objects utilized by system 10. In addition, servers 36 include ActiveX objects, Active server pages, and Microsoft Site Server Commerce. In an alternative embodiment, servers 36 include optional SMTP services. With the combination of MTS and MSCS, servers 36 provide a static load balancing mechanism, i.e., the same COM object can be active on multiple servers and not just available for fail-over scenarios. In an exemplary embodiment, servers 36 only provide MTS/COM service to system 10 and therefore provide performance enhancements over multi-tasked servers.

Servers 36 are connected to devices 14 through the Internet 50. The connection passes through a second primary firewall 40. Servers 36 are connected to primary firewall 40 through a fourth digital switch 42. In addition, servers 36 are connected to a secondary firewall 44 through fourth digital switch 42. In an alternative embodiment, servers 36 are connected to secondary firewall 44 through primary firewall 40. A control LAN management station 46 is connected to primary firewall 40 and secondary firewall 44 through a fifth digital switch 48. Primary firewall 40 includes an HTTP port, an SSL port, and an optional SMTP port. Firewalls 40 and 44 are connected to the Internet 50 through a sixth digital switch 52. User devices 14 are connected to the Internet 50 as described above with respect to FIG. 1.

Each device 14, in the exemplary embodiment, is a personal computer including a web browser. The communication in the exemplary embodiment is illustrated as being performed via the Internet, however, any other WAN type communication can be utilized, i.e., the systems and processes are not limited to being practiced via the Internet. In addition, and rather than a WAN, a LAN could be used in place of the WAN.

System 10 provides scalability, availability (fail-over) and performance at all tiers, while fully utilizing each node in server system 12. System 10 and devices 14 are configured to download and upload required data through a secure connection, from each other, for performing the required functions. Continuous enhancements provide compatibility to use new technology as it becomes available which ultimately reduce cost and improve efficiency

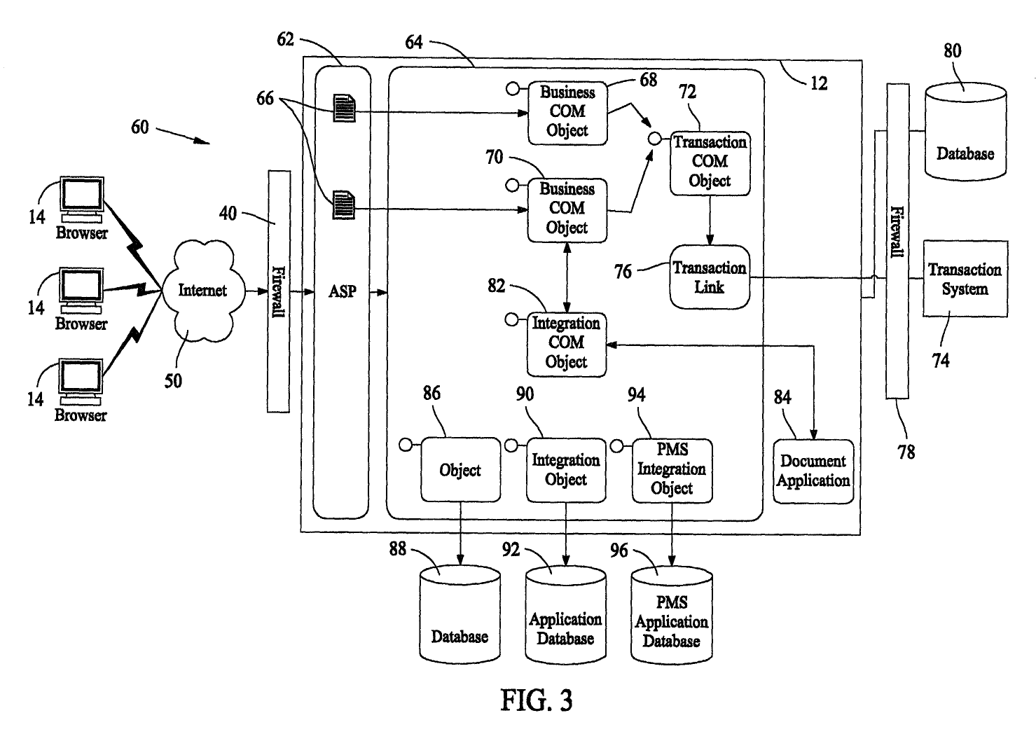

FIG. 3 is a block diagram of an exemplary application architecture 60 for Asset Finance System 10 (shown in FIGS. 1 and 2). Architecture 60 includes a presentation services layer 62 and an application services layer 64. Presentation services layer 62 includes a plurality of Active Server Pages (ASP) 66 that provide for the presentation and client-side validations, utilizing, for example, HTML and Javascript. Users access server system 12 by utilizing a device 14 including a browser (not shown), accessing the Internet 50, passing through a firewall 40, and accessing presentation services layer 62. Presentation services layer 62 includes a Web-based front-end customized to the user accessing system 10. For example, when a dealer enters system 10, make and model drop down lists display only the lists of makes and models for that dealer, and not for other dealers. Also, maximum dealer prices are specific to the dealer accessing system 10. The user ID input by the user indicates which user is accessing system 10 and system 10 then displays the appropriate customized information.

Application services layer 64 includes a business logic middle tier having a series of COM objects which implement business rules utilized by system 10. The business logic middle tier permits rapid configuration of asset finance programs specific to Dealers and End User requests without additional programming and customization. Within each asset finance program are different levels of approval that allow further customization of transaction workflow. This further customization permits the entering of certain parameters related to interest rate retention amounts, user access and feature availability.

In one embodiment, the business rules reside in application services layer 64. For example, application services layer 64 includes a business COM object1 68 and a business COM object2 70 linked to a transaction COM object 72 which interfaces with a transaction system 74. In an exemplary embodiment, transaction COM object 72 is integrated with a transaction link 76, and calls an appropriate function in transaction system 74 by opening an appropriate port on transaction system 74 via transaction link 76. Transaction system 74 performs functional processing and information is returned to the calling business logic object which then passes the information onto the appropriate ASP 66 that originated the transaction. Transaction COM object 72, transaction system 74 and transaction link 76 form a transaction utility. In one embodiment, the transaction utility is currently available from Experian Scorex and transaction link 76 is a transaction SDK.

Transaction system 74 includes a credit scoring tool and performs credit scoring, makes determinations regarding credit applications, and performs credit bureau checks for commercial and individual applicants. Transaction system 74 includes credit policy rules and determines a status of a credit application. In one embodiment, transaction system 74 is external to system 10 and is accessed through a firewall 78. In addition, a database 80 is external to server system 12 and is connected to server system 12 via firewall 78. In an alternative embodiment, database 80 resides within server system 12. Database 80 includes information pertaining to Customer Quote, Credit Application, Documented Applications, Dealership Programs, Dealership Types, Dealer Profile, Marketing Programs, Pricing, Tax Rates, Dealer Equipment, Customer Account History, Maximum Financing Terms, Leasing Factors, Maximum Residual, PMS Program to ICA mapping, and Credit Bureau information.

In addition, business COM object2 70 is linked to a document generation integration COM object 82 which forms a portion of a document generation utility. Document generation integration COM object 82 is linked with a document generation application 84. More specifically, business COM object2 70 is linked to document generation integration COM object 82 which interfaces with document generation application 84 and calls on document generation application 84 to generate a PDF document and store the document on an appropriate file system. A handle (pointer) to the file is returned to the calling object which is passed back to the respective ASP 66 for display on device 14. In an alternative embodiment, document generation application 84 creates a PDF file merged with the data.

Application services layer 64 also includes at least one object integrated with an external data repository. In one embodiment, application services layer 64 includes an electronic signature object 86 linked to an electronic signatures database 88, an Interactive processing system Integration object 90 linked to an Interactive processing system database 92, and a PMS Integration object 94 linked to a PMS Application database 96. Databases 88, 92, and 96 are external data repositories. Interactive processing system database 92 receives a daily extract of approved credit applications from system 10 which is used for verification when deals are booked. The extract obtains changes and new credit approvals for a predetermined period of time. PMS Application database 96 provides information to database 80. In one embodiment, the COM objects are built, for example, utilizing MS Visual Basic. Alternatively, the COM objects are built utilizing MS Visual C++.

Asset Finance System 10 is used initially to generate finance quotations or gather application information from Dealers or End Users requiring financing services. The information is input in a customized series of screens and yields, in one embodiment, a series of payment alternatives, a finance quotation or credit application. Specific information about the customer (name, address, etc.) is retained in the database of system 10 to expedite subsequent submissions of information. At the request of the individual inputting the information, the application is submitted electronically. This results in the automated credit scoring of the transaction which includes links and inputs from third party credit rating agencies as well as accessing historical information on the applicant's history if available. If certain thresholds are met, an instant decision is rendered based on the applicant information. If these thresholds are not met, the application information is forwarded electronically to the attention of a credit analyst.

The credit analyst uses the imbedded workflow of the system to gather additional pieces of information sufficient to yield a decision on the application and electronically communicates this information back to the individual who submitted the information. Functionality imbedded in the system allows the analyst to delay the delivery of responses for periods of time to allow 100% consistency in the response time to user requests. The analyst can change components of the transaction and these changes are communicated back to the person who entered the information in the form of different colors on transaction summary screens for components of the transaction that were changed by the analyst. The analyst and the customer communicate electronically during this phase of processing in the form of an appeal process in the event that the initial decision rendered by the analyst is not acceptable and other alternatives acceptable to both parties are available.

All information is retained throughout this process to be used for future analysis and in the event that information in entered applications changes and needs to be resubmitted to the analyst. The Dealers and End Users have the opportunity to review a list of all the transactions they have entered into the system at anytime and to see the current status of these transactions.

After a transaction has been approved by the credit analyst, the Dealer or End User can access the system to generate all required documentation necessary to complete the transaction. The Dealer or End User accesses the documentation feature and, by entering or modifying additional information in a step by step process, generates the required documentation for email transmission or to be printed and executed by the relevant parties. A variety of documentation types is available based on the information submitted along with specific requirements of the transaction.

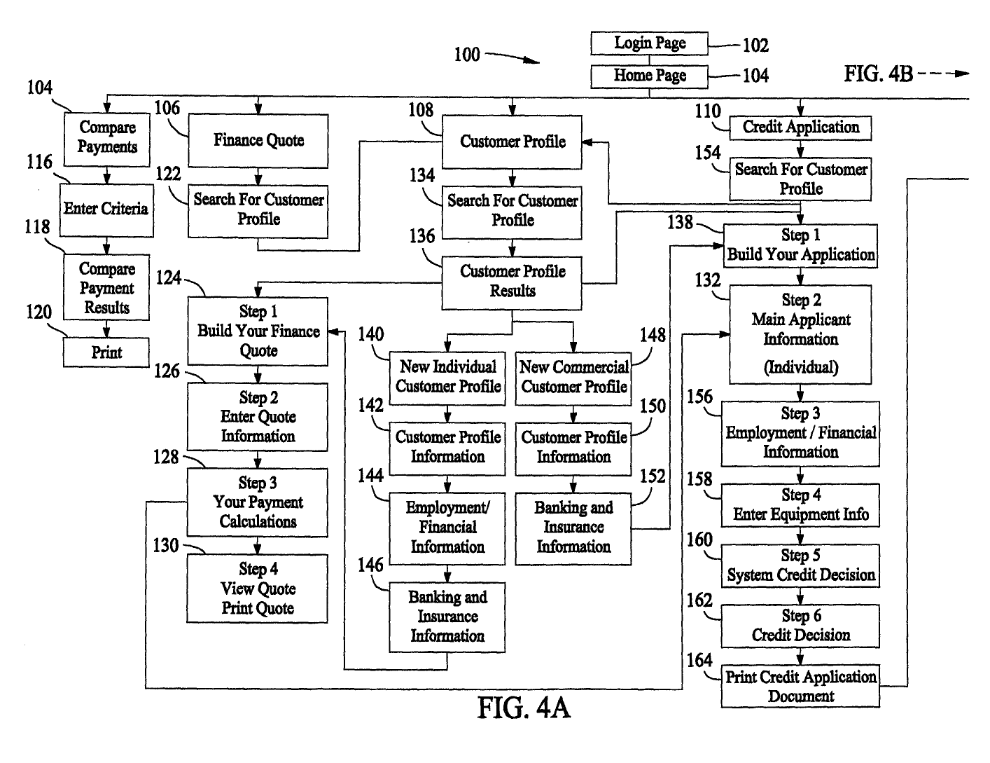

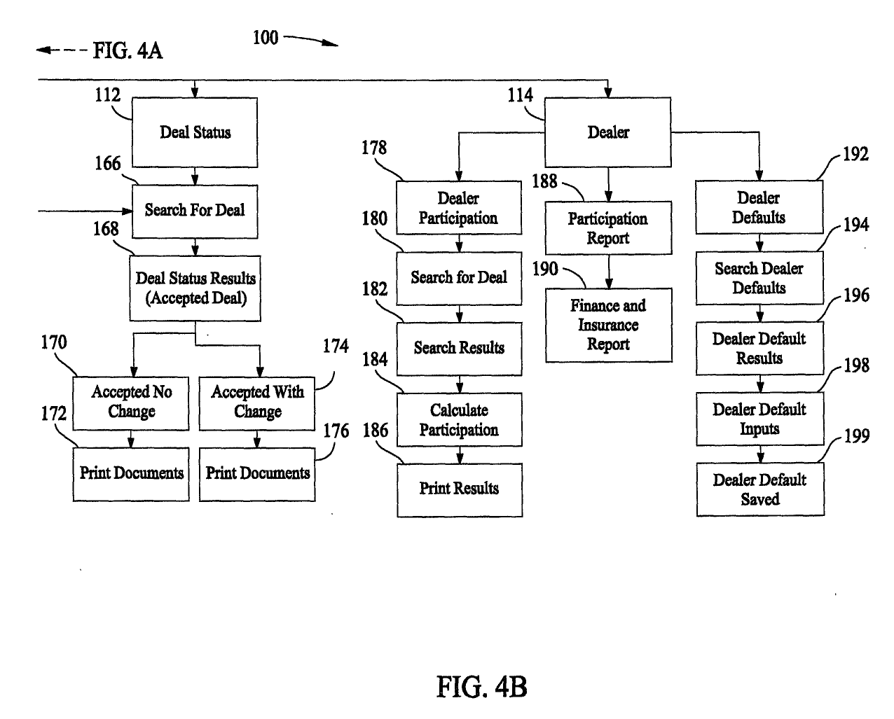

FIG. 4 is a workflow diagram of a method 100 of obtaining credit finance information performed by Asset Finance System 10 (shown in FIGS. 1 and 2). System 10 is accessed by a user through a Login Page 102, that after successful login, transmits a Home Page 104 of the business entity's web site. The user is one of a dealer sales person, an F&I manager, a dealer principal, an end-customer, a credit analyst, and an administrator. Sales people typically use system 10 to obtain quotes, receive credit approval, and generate and retrieve documents. F&I managers and dealer principals typically use system 10 to track deals being booked and the profit per deal, with a particular interest in dealer rate and additional products sold such as insurance. An end-customer is any user on the Internet who logs onto system 10 to receive a quote directly from system 10. In an alternative embodiment, end-users apply for credit directly, instead of through a dealer. Credit analysts utilize system 10 to review the credit analysis performed by system 10. Administrators typically use system 10 to create documents for customers that do not have access to computers and to verify when a deal is funded.

In one embodiment, the received information is submitted by the user to obtain at least one of a Compare Payments 106, a Finance Quote 108, a Customer Profile 110, a Credit Application 112, a Deal Status 114, and a Dealer Information 116. If a user selects Compare Payments 104, the user is prompted to enter 116 criteria relating to a potential deal. System 10 displays a listing of results that are compared 118 by the user. The user has the option to print 120 the results.

Alternatively, the user can obtain Finance Quote 106. System 10 queries the user regarding whether the user wants to search 122 for a previously input customer profile. If the user wants to create a new customer profile, system 10 prompts the user to setup a customer profile 108 as will be explained in detail below. If the user does not want to create a new customer profile, the user is then able to build 124 a Finance Quote. System 10 prompts the user to input information sufficient to obtain a finance quote based on payment options input by the user and the financing conditions. System 10 then determines 128 an appropriate payment plan quote which is displayed on the user's device. The user has the option to view 130 the quote and print the quote. After system 10 displays the payment plan quote, the user has the option to proceed with a credit application 110 and the user is advanced to a main applicant information page 132. Alternatively, the user can exit the web site.

Another option for the user is to build a customer profile 108, either from a blank form, or from a partially completed form. The user accesses system 10 to search 134 for a previously entered customer profile. System 10 displays the search results 136 to the user. If a completed previously enter customer profile is found, system 10 transmits a Build your Application 138 section of the web site to the user's device. If a completed customer profile is not found, system 10 determines whether the user is an individual user or a commercial user.

To build an Individual customer profile 140 the user enters customer profile information 142 including Employment/Financial information 144 and Banking and Insurance Information 146. Once the information is entered and accepted by system 10, the user has the option to Build a Finance quote 124. Alternatively, the user has the option to build a credit application 138.

To build a commercial customer profile 148, the user enters customer profile information 150 including banking and insurance information 152. Once the information is entered and accepted by system 10, the user has the option to build a credit application 138.

The user also has the option to submit a credit application 110 through system 10. Initially, the user enters information sufficient to enable system 10 to search 154 for a previously submitted customer profile. If one is found, the user continues with the credit application. If a customer profile is not found, the customer profile 108 portion of the web site is transmitted to the user. To continue with the credit application, the user is prompted to build 138 the credit application by entering 132 information pertaining to the main applicant. The information submitted by the user to build the credit application includes a user ID and a password that the user inputs at login. System 10 analyzes the user ID to determine a level of access the user has to system 10. For example, access to system 10 is restricted by menu option, field, and data. Dealer salespersons are only able to view their own deals, F&L managers and dealer principals are able to view all deals for the salespeople working for them, and finance institution personnel are able to view all deals and have access to all menu options.

In one embodiment, there are four access levels for dealers. Level 1 is a complete access level that provides access to any deals booked by salespersons reporting to the dealer. System 10 accepts information pertaining to quote, credit application, and document information. The user is able to modify dealer defaults and view a deal status report. Level 2 is an access to quote, credit and documents level with no ability to modify dealer reserve. System 10 accepts quotes and credit applications from a level 2 user and generates documents for the deal. The user is only able to view the user's deals. Level 2 access does not include the ability to modify dealer reserve. Level 3 is an access to quote and credit application components level. System 10 accepts information pertaining to the quote and credit application but does not generate the deal documents. Level 4 access provides quote access so a user is able to utilize the system to generate a quote for a customer.

In addition, there a two levels of financial institution access, credit access and administration access. Credit access allows the user access to a review module and to a documents module. In addition, Credit access allows the user to view the deal status report. Administration access allows the user access to the quote, credit (view only access) and document module and allows the user to view a deal status report.

System 10 includes an on-line tutorial that guides a user through submitting a credit application, obtaining approval, and printing the deal documents. System 10 prompts the user to input main application information 132, Employment/Financial information 156, and equipment and trade-in information 158. In an alternative embodiment, system 10 prompts the user to enter information pertaining to attachment information.

System 10 performs a credit search by accessing at least one external credit bureau database and provides 160 a credit decision based on the credit application. In an exemplary embodiment, the information pertains to finance applications, such as from the transportation, construction, and material handling markets. System 10 interacts with a transaction application which queries a relational database to obtain information for scoring the application and returns a credit decision using an identified key field. In one embodiment, the transaction application obtains a list of records from a credit bureau for commercial and individual applicants based on input parameters and criteria.

As indicated previously, the transaction application system is linked to at least one credit bureau and obtains credit reports from the credit bureaus. In one embodiment, the credit bureaus are Dun & Bradstreet for commercial applications and Equifax for commercial and individual applicants. The transaction application then processes the credit report and generates and supplies a credit decision to system 10 such as declined, accepted, system referred, and others. In one embodiment, the transaction application queries the relational database server so all of the application information does not need to be supplied to the transaction application as part of the input parameters. In one embodiment, a credit application is resubmitted to the transaction application after the application has been modified. The transaction application then queries the credit bureaus regarding the modified applications.

If certain thresholds are met, an instant credit decision 162 is rendered based on the applicant information and the decision is electronically transmitted to the user along with the appropriate documents. If certain thresholds are not met by the application, the application information is forwarded electronically to the attention of a credit analyst. After receiving information from the transaction application, the credit analyst reviews the credit application and makes a credit decision. The credit analyst makes the decision based, at least in part, on information received from system 10 such as credit information obtained from a credit bureau, the customer's payment history with the financial institution, and other available information. System 10 then transmits one of accept, decline, refer, or pend regarding the credit application to user device 14. In one embodiment, system 10 transmits a reason for declining or pending the deal to device 14. The user can then print 164 the credit application documents and proceed to obtain funding.

System 10 prompts the user to search 166 for a pending deal, or to initiate a new deal. System 10 obtains 168 existing deal status results if they have been accepted. System 10 transmits to device 14 a payment plan approved by system 10. In an exemplary embodiment, the payment plan includes one of stretch, skip, and accelerated payment options. In addition, a user can choose from a variety of rate type alternatives including fixed rate and floating rate structures. For example, for a floating rate structure, the user inputs a spread percentage and system 10 utilizes the input information to calculate the payment plan. In one embodiment, system 10 also supplies and compares a variety of payment plans to provide the customer with multiple payment options. In addition, system 10 is configured to process multiple drawdowns from a single credit approval and track how much credit has been used as well as the remaining balance.

For the embodiment in which the customer is a dealer, system 10 includes a dealer pending process that enables a dealer to make changes to a finance application that the dealer has not yet submitted to obtain credit approval. In one embodiment, the dealer pends an application to wait for missing information. In an alternative embodiment, system 10 transmits reminders to the dealers informing them of credit decisions and missing information. The reminders are transmitted via email.

Method 100 further includes accepting 170 the funding deal with no change. Once the user agrees to the acceptance, system 10 prompts the user to print 172 the appropriate documents to finalize the deal. If changes are to be submitted to the deal, system 10 will accept 174 the deal changes from a customer after the deal has been approved if the changes are within certain predefined limits specific to that customer. Any customer changes to an approved deal that exceed the predefined limits are flagged by system 10. System 10 then transmits a warning to the customer indicating that the proposed changes may result in delays during funding. The customer has the opportunity to withdraw the proposed changes and proceed with the unaltered application. Alternatively, the customer has the opportunity to maintain the altered application and accept any resulting delays. System 10 updates the deal status until actual funding takes place. Thus updates may be provided after credit approval and document generation depending on when the request for deal change was made.

System 10 transmits 176 to device 14 information such that the user can print deal documents. In an alternative embodiment, the information is transmitted to the user such that the user can download the deal documents to a disk and save them. The user is able to change the name, address or other information and proceed to generate the deal documents. In one embodiment, the deal may only be documented if the deal has been approved by system 10. The information also includes descriptions of each document to provide the user with an understanding of the documents and which documents the user should print and use.

Dealers can access system 10 to obtain information on dealer participation. Dealers can search 180 for deals, review 182 the search results, calculate 184 participation, and print 186 any applicable results. In addition, dealers can access and create participation reports 188 as well as finance and insurance reports 190. Further, dealers can create dealer default settings 192 within system 10 such that when a user from that dealer logs onto the system, a customized user interface greets the user. To build customized dealer defaults, the dealer searches 194 existing dealer defaults and system 10 displays 196 those results. The dealer sets 198 dealer default inputs and the dealer defaults are saved 199 by system 10.

In addition, system 10 provides dealers with deal status and dealer profit information. The dealer may view the dealer's quotes, applications, and documented deals. In an alternative embodiment, the dealer may view the quotes, applications, and documented deals for all personnel reporting to the dealer. The dealer may also view a report of dealer profit from a number of sources, including dealer reserve, second level residual, and others. System 10 tracks deals by a variety of keys, such as, credit analyst, user, and deal status.

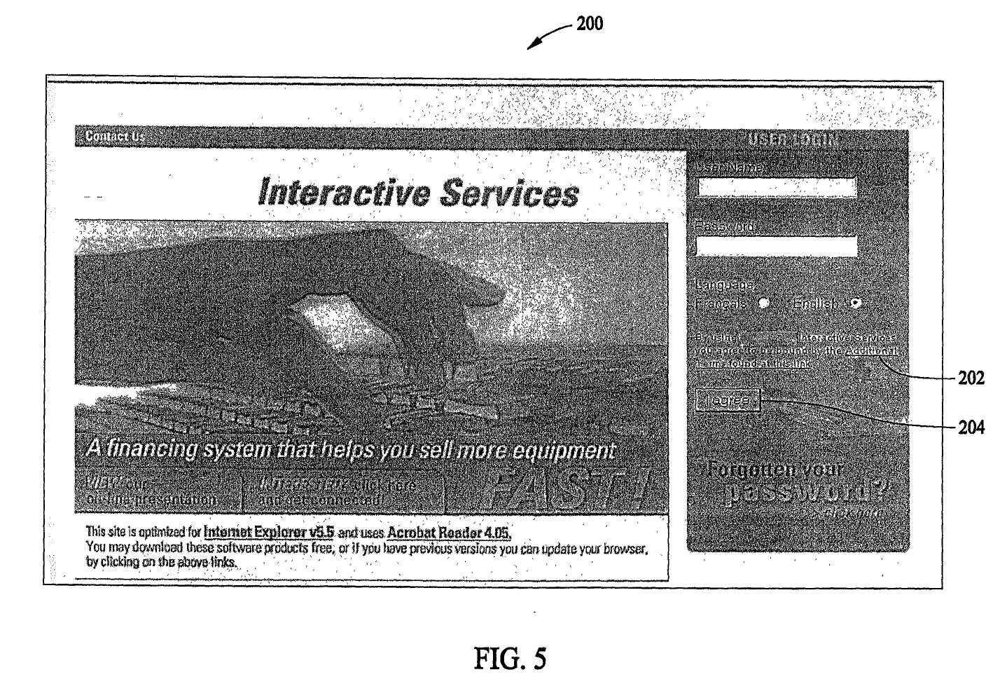

FIG. 5 is an exemplary embodiment of a user interface 200 displaying a Login Page of Asset Finance System 10 (shown in FIGS. 1 and 2) and prompting a user to log into the system. User interface 200 prompts the user to input a user name and a password. User interface 200 also prompts the user to select either French or English. In addition, user interface 200 requests that the user agree to be bound by the terms and conditions set forth at link 202. In one embodiment, if the user selects I agree button 204, and a correct user name and password are supplied, the user is allowed access to the remainder of the web site. If the user does not agree to be bound by the terms set forth at link 202, the user is denied access to the remained of the web site.

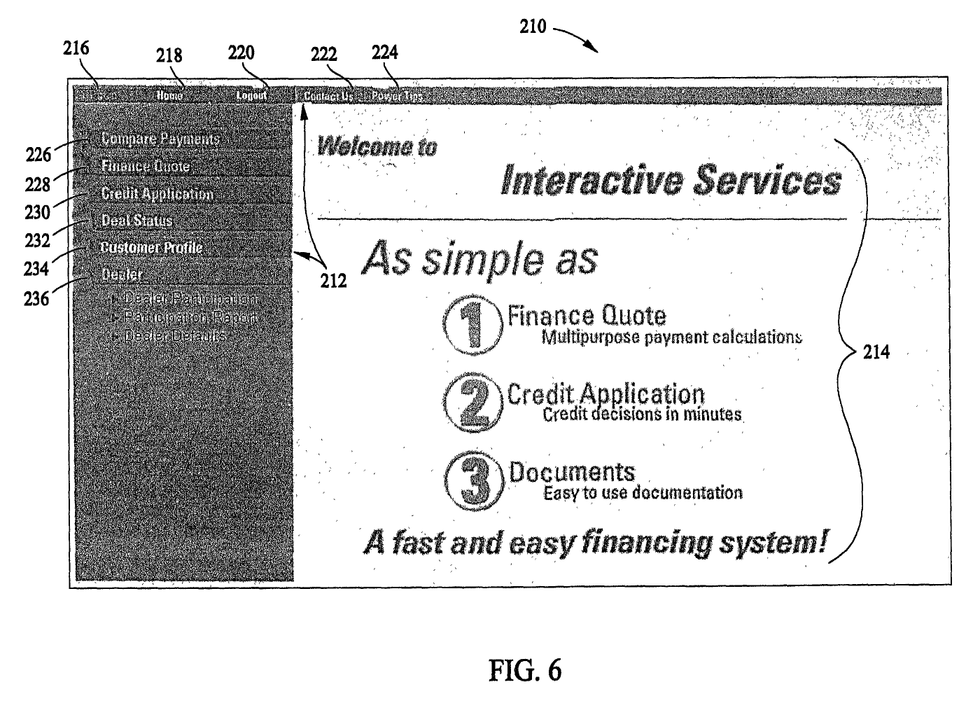

FIG. 6 is a user interface 210 displaying a Home page of system 10. Each page of the web site includes two main components. The first component is the Navigation Bar 212 and the second main component is the Input Screen 214. Navigation Bar 212 is utilized to navigate through the web-site or to end the session (cancel). The Input Screen is utilized to enter the information required to complete the Credit Application. Some of the Input Screen fields are mandatory and if not completed the user will not be able to advance to the next screen. Navigation Bar 212 includes a business home page button 216, a system home page button 218, a logout button 220, Contact us button, and a Power Tips button 222. Power Tips button 222 is an on-line frequently asked questions help link.

Navigation Bar 212 also includes a Compare Payments button 224, a Finance Quote button 226, a Credit Application button 228, a Deal Status button 230, and a Customer Profile button 232. Compare Payments button 224 is utilized to compare monthly payments for up to three different marketing programs on a single page. Finance Quote button 226 is utilized to create a new quote for either an existing customer from your customer database or a new customer that will automatically be added to a customer database. Credit Application button 228 is utilized to submit a credit application for either commercial or individual clients directly to a finance analyst. Customer profile button 234 is utilized to update and edit existing customer profiles in interactive services. Navigation Bar 212 also includes a Dealer button 234 that includes a Dealer Participation link 236, a Participation Report 238, and a Dealer Defaults link 240. Dealer button 234 and associated links 236, 238, and 240 are utilized to check and print dealer participation on all interactive services deals and to set and save defaults for a dealership including rate participation, down payment amount, and term length.

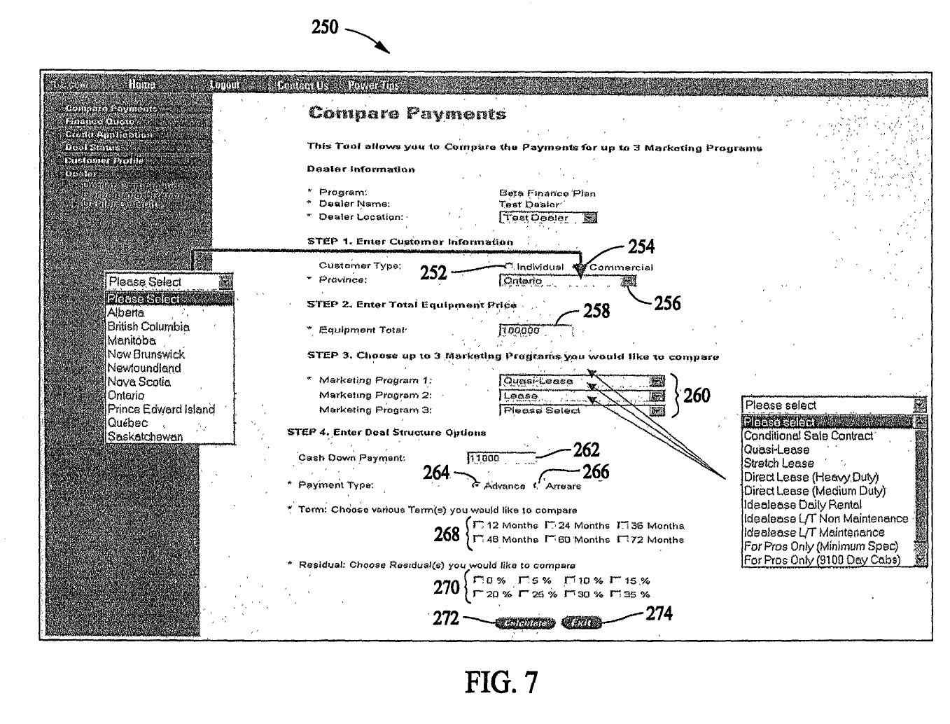

FIG. 7 is a user interface 250 displaying a Compare Payments page that is accessed by selecting Compare Payments button 226 on Home page 210. A user is prompted to complete a four step process that provides system 10 with the information to be used to generate a comparable quote. The first step is to enter customer information by selecting either an individual customer type button 252 or a commercial customer type button 254 and selecting an appropriate Province from a Province pull down menu 256 that lists a number of provinces or states of a region. The second step includes entering a total equipment price by inputting the information into an information block 258. The third step includes choosing up to three marketing programs the user would like to compare by accessing three respective pull down menus 260 that each list different types of financial transactions. The fourth step includes entering deal structure options by entering a cash down payment into an appropriate information block 262 and by selecting either an Advance payment type button 264 or an arrears payment type button 266. In addition, a term 268 is chosen by selecting one of 12 months, 24 months, 36 months, 48 months, 60 months, and 72 months. The fourth step further includes choosing residuals 268 such as 0%, 5%, 10%, 15%, 20%, 25%, 30%, and 35%. User interface 250 also includes a calculate button 272. Selection of calculate button 272 enables system 10 to utilize the input information to perform an appropriate comparison. User interface 250 also includes an exit button 274 that exits the user from the web site.

The results generated by system 10 after calculate button 272 is selected are output in table form with a comparison of only valid deal structures. The table shows the marketing program, term, residual and monthly payment amount for easy comparison. Since only valid deal structures appear, the compare sequence must be repeated with a different deal structure if the ideal marketing program is not output. Once the user determines a suitable marketing program and payment structure, the user submits an application or the user navigates to Finance Quote to further refine the deal structure before submitting an application in the credit sequence.

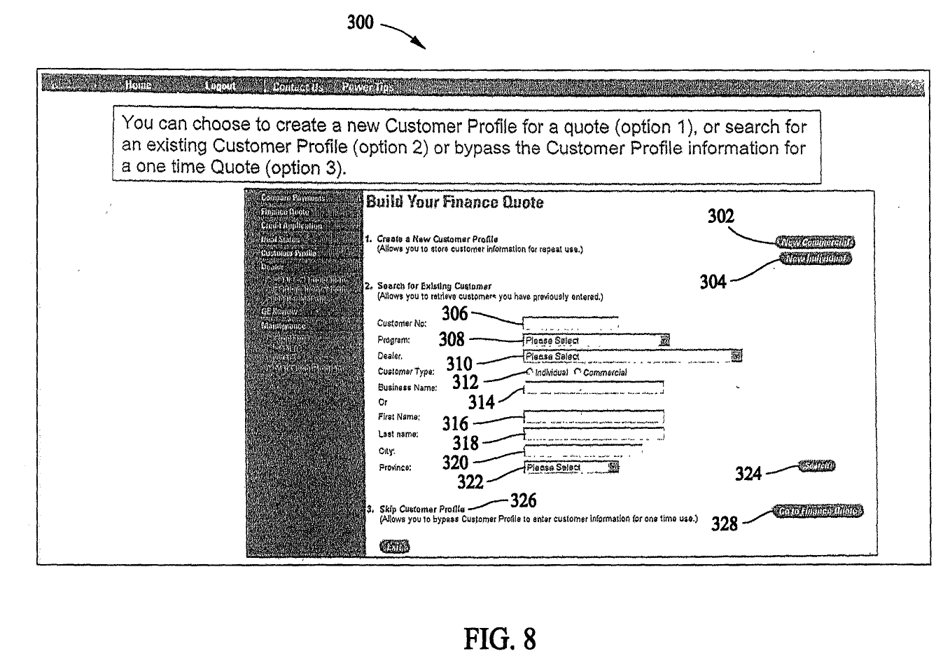

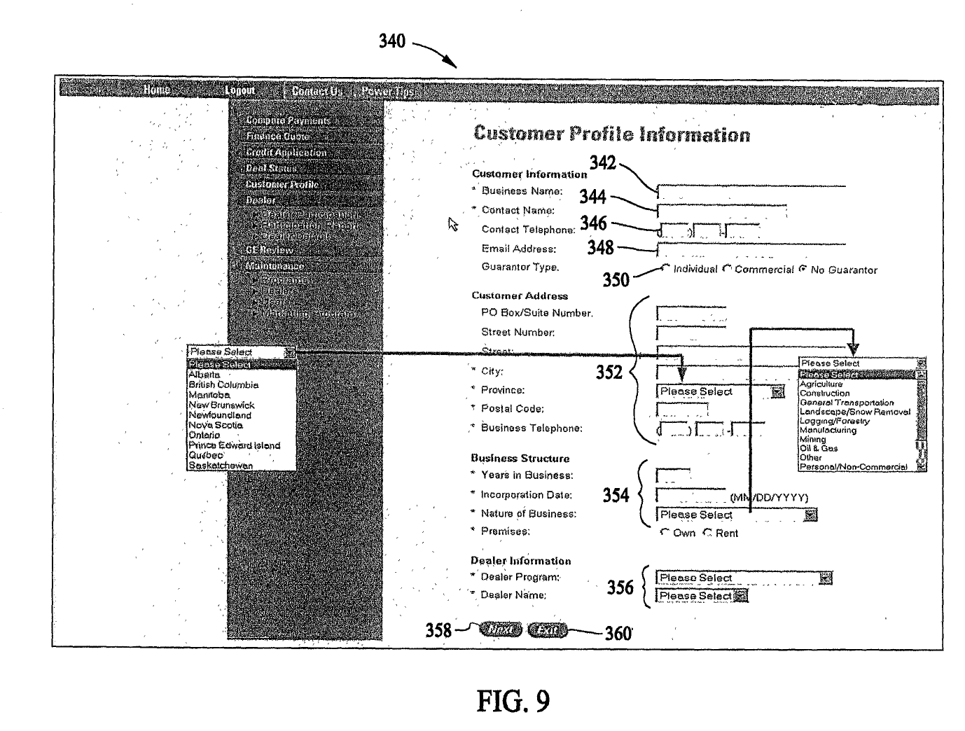

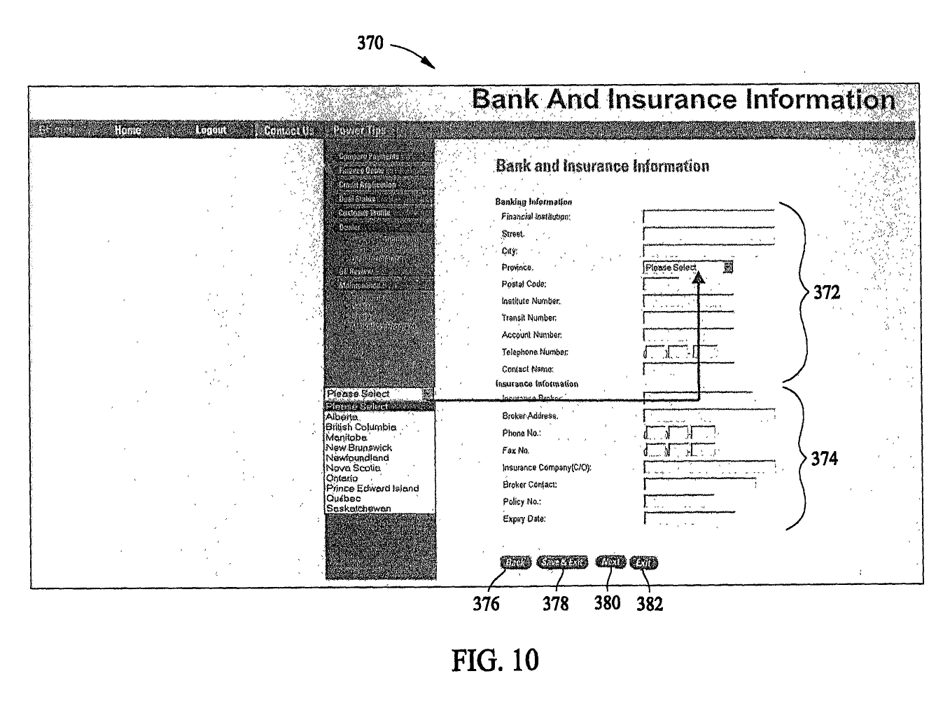

FIG. 8 is a user interface 300 displaying a Finance Quote main page that is accessed by selecting Finance Quote button 228 on home page 210. User interface 300 includes a New Commercial button 302 that links the user to a New Commercial customer page (shown in FIG. 9) and a New Individual button 304 that links the user to a New Individual customer page (shown in FIG. 10). Selection of either button 302 or button 304 enables system 10 to create a new customer profile. Alternatively, the user can request the system to search for an existing customer, i.e., customers previously entered into system 10. The search criteria include a customer number 306, a program 308, a dealer 310, a customer type 312, and a business name 314. The search criteria also include a first name 316, a last name 318, a city 320, and a province 322. Once the requested information is input, search button 324 is selected and system 10 searches the appropriate database for a matching customer. If system 10 finds multiple matches to the search criteria, each matching entry will be displayed to the user with a prompt to select the correct customer profile. User interface 30 also includes a Skip Customer Profile section 326 that enables a user to access a Finance Quote quickly by selection of Go to Finance Quote button 328 and enter customer information for a single time purpose. If the quote is taken to a credit application, the customer information will not be saved and there will be no record of this customer in the customer profile.

FIG. 9 is a user interface 340 displaying a New Commercial Customer Profile page that is accessed by selecting New Commercial button 302 on Finance Quote page 300. User interface 340 includes information blocks for receiving a business name 342, a contact name 344, a contact telephone number 346 and an email address 348. In addition, the user is prompted to select an appropriate guarantor 350, if a guarantor will be utilized for the transaction. If guarantor 350 is selected, system 10 transmits a Guarantor page (not shown) to the user for completion. The Guarantor page includes information requests directed to obtaining contact information of the guarantor. User interface 340 also includes information blocks 352 pertaining to Customer address, information blocks 354 pertaining to business structure, and information blocks 356 pertaining to dealer information. In addition, user interface 340 includes a Next button 358 to proceed to the next user interface and an Exit button 360 to exit the web site. The commercial customer profile can be changed by selecting the profile information and making edits in the appropriate locations. Such changes will be accepted by system 10 if system 10 is directed to save such information.

FIG. 10 is a user interface 370 displaying a Bank and Insurance Information page that is accessed by selecting Next button 358 on user interface 340. User interface 370 includes information blocks 372 for receiving banking information regarding the financial institution utilized by the user's company and information blocks 374 for receiving insurance information including the insurance broker and associated information. User interface 370 also includes a Back button 376 to transmit the previous user interface to the user, a Save and Exit button 378 to save the input information and leave the web site, a Next button 380 to transmit the next user interface to the user, and an Exit button 382 to exit the web site. The bank and insurance information can be changed by selecting the bank and insurance information and making edits in the appropriate locations. Such changes will be accepted by system 10 if system 10 is directed to save such information.

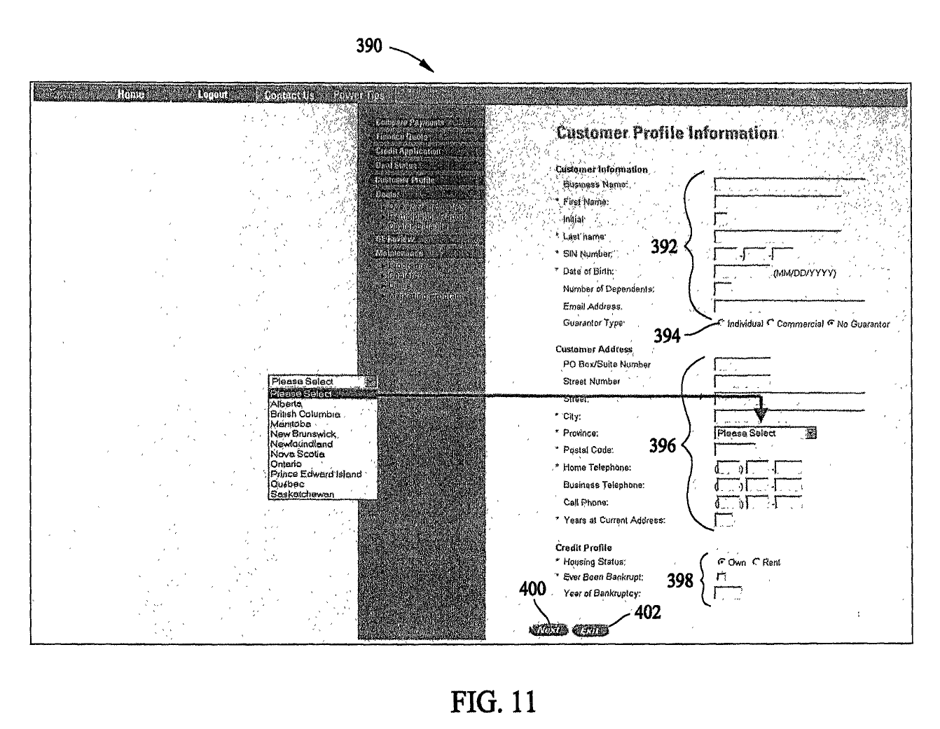

FIG. 11 is a user interface 390 displaying a New Individual Customer Profile page that is accessed by selecting New Individual button 304 on Finance Quote page 300. User interface 340 includes information blocks 392 for receiving customer information including guarantor type 394. The user is prompted to select an appropriate guarantor, if a guarantor will be utilized for the transaction. If guarantor 394 is selected, system 10 transmits a Guarantor page (not shown) to the user for completion. The Guarantor page includes information requests directed to obtaining contact information of the guarantor. In addition, user interface 390 includes information blocks 396 for receiving customer address information and information blocks 398 for receiving a credit profile of the customer. Accurate and complete information supplied in the information blocks highlighted by an asterisk will increase the possibility of an instant decision and will decrease turnaround time for the application. User interface 390 also includes a Next button 400 to transmit the next user interface to the user and an Exit button 402 to exit the web site. The individual customer profile can be changed by selecting the profile information and making edits in the appropriate locations. Such changes will be accepted by system 10 if system 10 is directed to save such information.

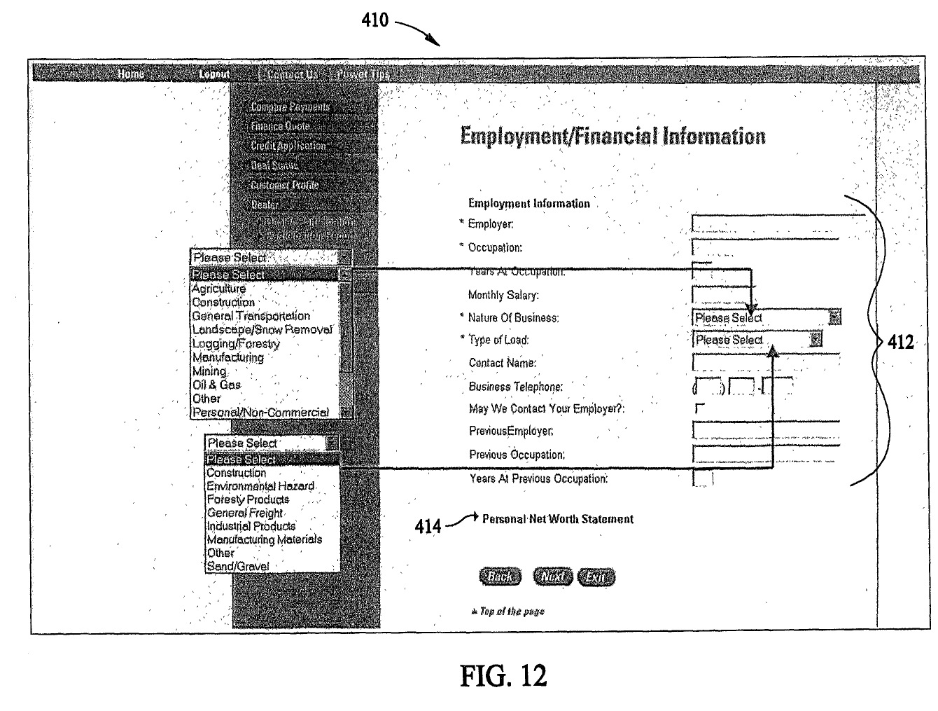

FIG. 12 is a user interface 410 displaying a first portion of an Employment/Financial Information page that is accessed by selecting Next button 400 on user interface 390. User interface 410 includes information blocks 412 for receiving employment information of the individual customer and a link 414 to enter information into a personal net worth statement. The employment information can be changed by selecting the employment information and making edits in the appropriate locations. Such changes will be accepted by system 10 if system 10 is directed to save such information.

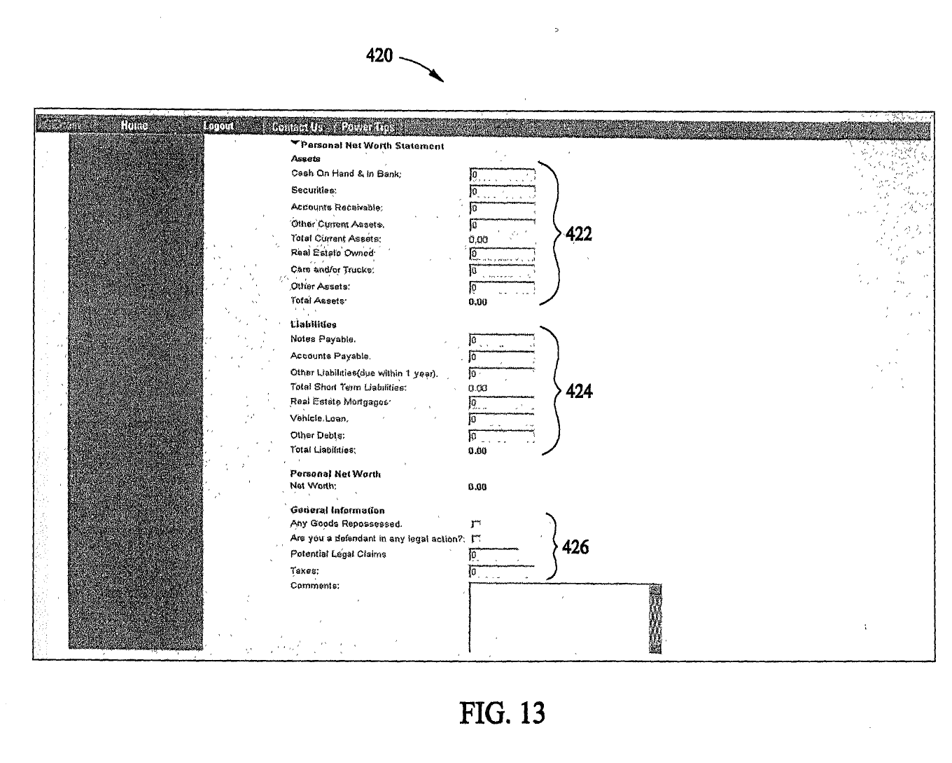

FIG. 13 is a user interface 420 displaying a Personal Net Worth Statement page that is accessed by selecting link 414 on user interface 410 shown in FIG. 12. User interface 420 includes information blocks for receiving information pertaining to the personal net worth of the individual. Such information blocks include an assets information block group 422, a liabilities information block group 424, and a general information block group 426. System 10 determines the customer's net worth based on the information input to user interface 420. The personal net worth statement can be changed by selecting the net worth statement information and making edits in the appropriate locations. Such changes will be accepted by system 10 if system 10 is directed to save such information.

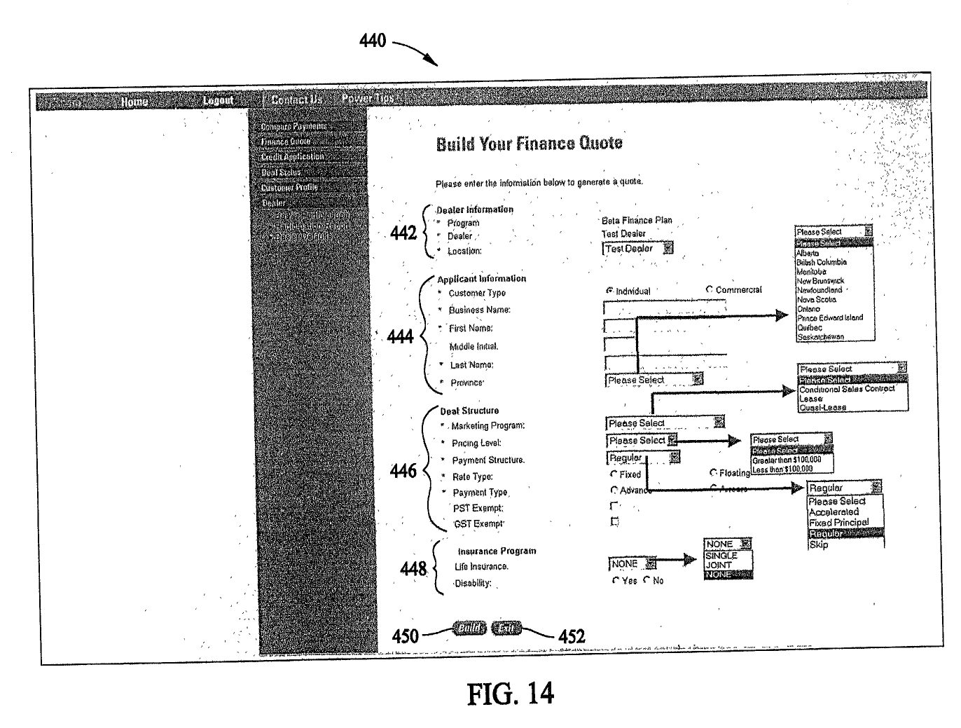

FIG. 14 is a user interface 440 displaying a Build Your Finance Quote page that is accessible after a customer profile has been built or selected. User interface 440 includes a Dealer Information portion 442 that is populated based on the user's login ID and password. User interface 440 also includes an Applicant Information portion 444 that is populated based on information input to one of user interface 300 (shown in FIG. 8), user interface 340 (shown in FIG. 9), and user interface 390 (shown in FIG. 11). If information has not previously been input at one of user interfaces 300, 340, and 390, the user then inputs the requested information in the associated information blocks. User interface 440 also includes a Deal Structure portion 446 that is utilized to determine the suitable deal structure for the customer, such as, marketing program, pricing level, payment structure, and rate type. User interface 440 further includes an Insurance Program portion 448 that includes information blocks pertaining to life insurance and disability insurance. User interface 440 also includes a Build button 450 to transmit the next user interface to the user, and an Exit button 452 to exit the web site.

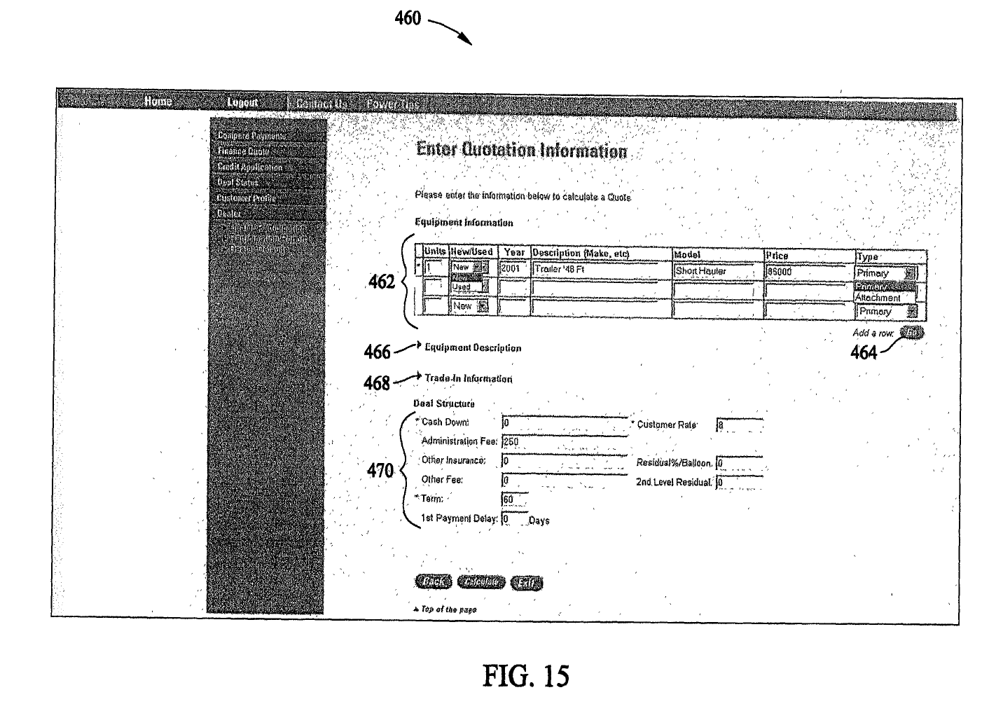

FIG. 15 is a user interface 460 displaying an Enter Quotation Information page that is accessed by selecting Build button 450 on user interface 440 shown in FIG. 14. User interface 460 prompts the user to input Application information, Value of Application, Financing Conditions and Insurance. User interface 460 includes an Equipment Information portion 462 that includes associated information blocks pertaining to number of units, new/used, year, description, model, price and type of equipment. If there are more than three pieces of equipment to be entered, the user selects the Go button 464 to add another row to the table. Additional information can be supplied by selecting Equipment Description link 466. User interface 460 also includes a Trade-in Information link 468 that, upon selection, supplies a Trade-in Information table (not shown) to the user for inputting information pertaining to trade-ins. User interface 460 also includes a Deal Structure portion 470 User interface 460 further includes a Back button 472 to transmit the previous screen to the user, a Calculate button 474 to proceed to the next user interface, and a next button 476 to exit the web site.

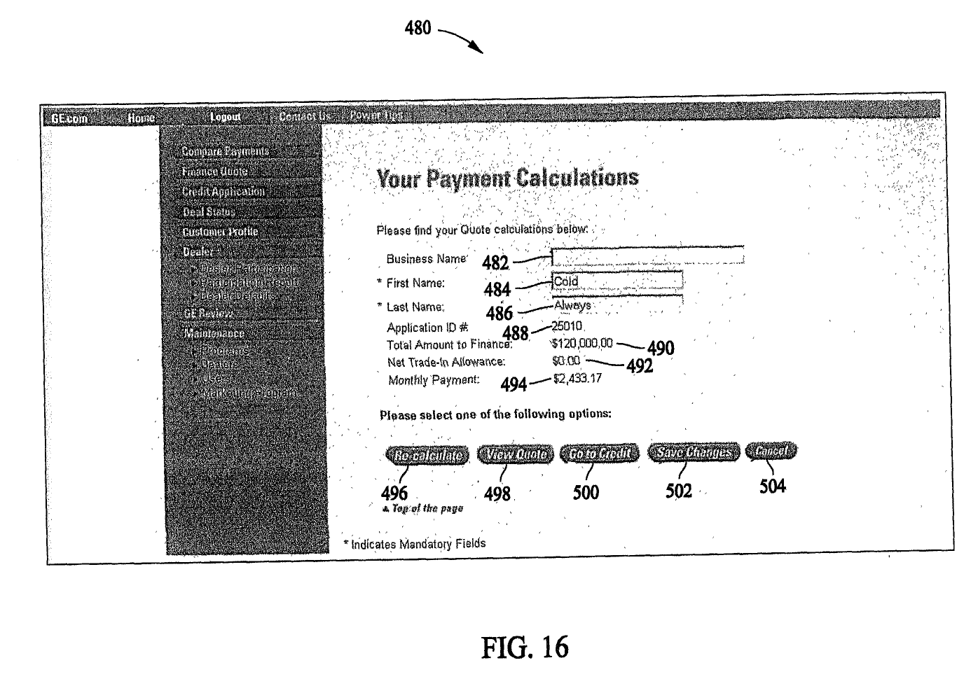

FIG. 16 is a user interface 480 displaying a Payment Calculation page that is accessed by selecting Calculate button 474 on user interface 440 shown in FIG. 15. User interface 480 includes information blocks pertaining to Business Name 482, First Name 484, Last Name 486, Application ID#488, Total Amount to Finance 490, Net Trade-in Allowance 492 and Monthly Payment 494. In addition, user interface 480 includes a Re-calculate button 496, a View Quote button 498, a Go to Credit button 500, a Save Changes button 502, and a Cancel button 504. Application ID # is not populated until the user selects either View Quote button 498 or Save Changes button 502. Monthly Payment block 494 is populated by system 10 based upon information supplied on the previous user interfaces. Selection of Re-calculate button 496 transmits the previous screen to the user to enable the user to change information supplied to system 10. Selection of View Quote button 498 instructs system 10 to print a copy of the quote for the user's records or the customer's records. Selection of Go to Credit button 500 allows the user to obtain instant approval on the request. Selection of Cancel button 504 exits the user from the present finance quote and deletes the quote from system 10.

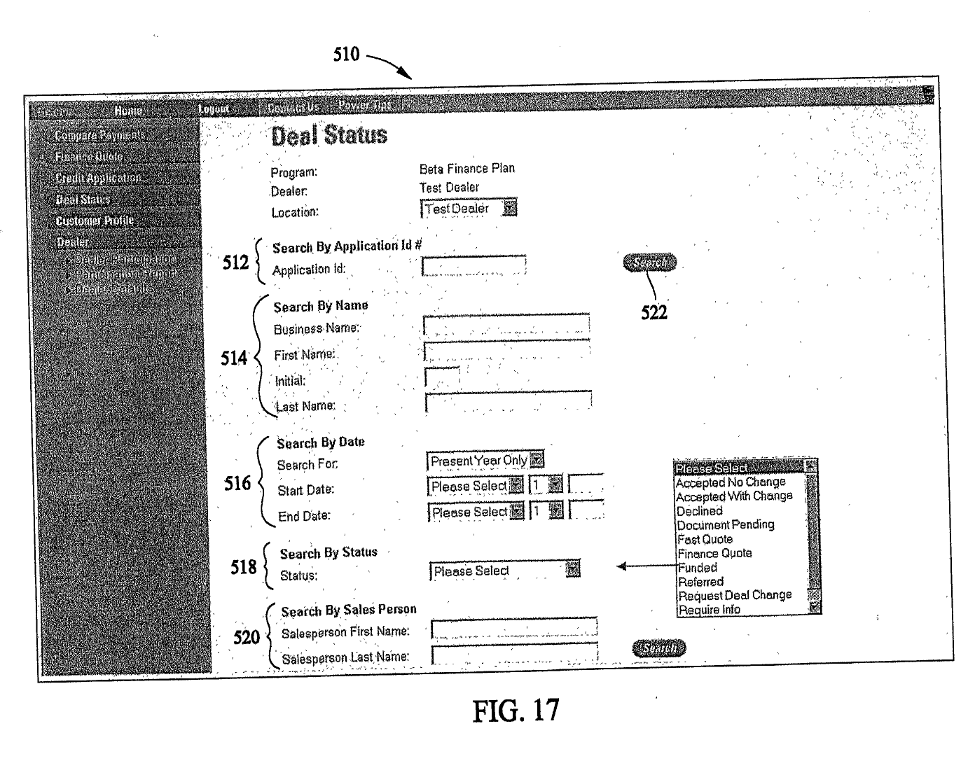

FIG. 17 is a user interface 510 displaying a Retrieving Saved Quote page that is accessed by selecting a Deal Status button 232 found in Navigation Bar 212 of the user interfaces. The user retrieves an existing quote by submitting information for at least one of an Application ID 512, Name 514, Date 516, Status 518, and Sales Person 520 by selecting a Search button 522. A list of deals that satisfy the search criteria is then retrieved by system 10. System 10 transmits to user device 14 (shown in FIGS. 1 and 2) information pertaining to Application ID, First Name, Last Name, Business Name, Sales Person, and Status. System 10 provides the user with additional details regarding any of the above listed information categories and allows the user to drill down on any of the information categories to view and modify the quote.

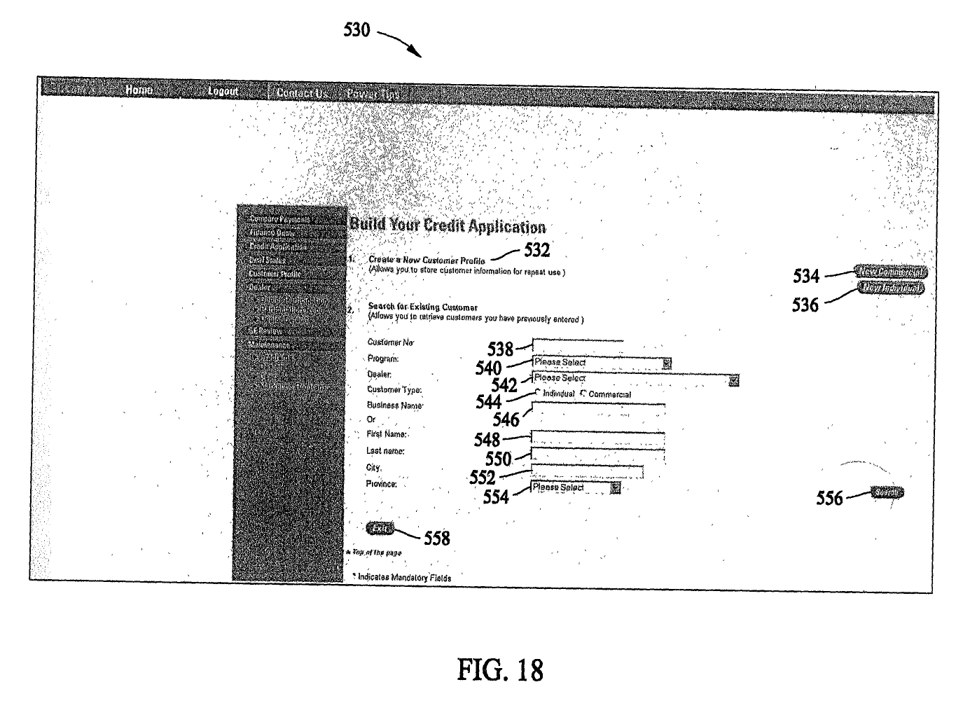

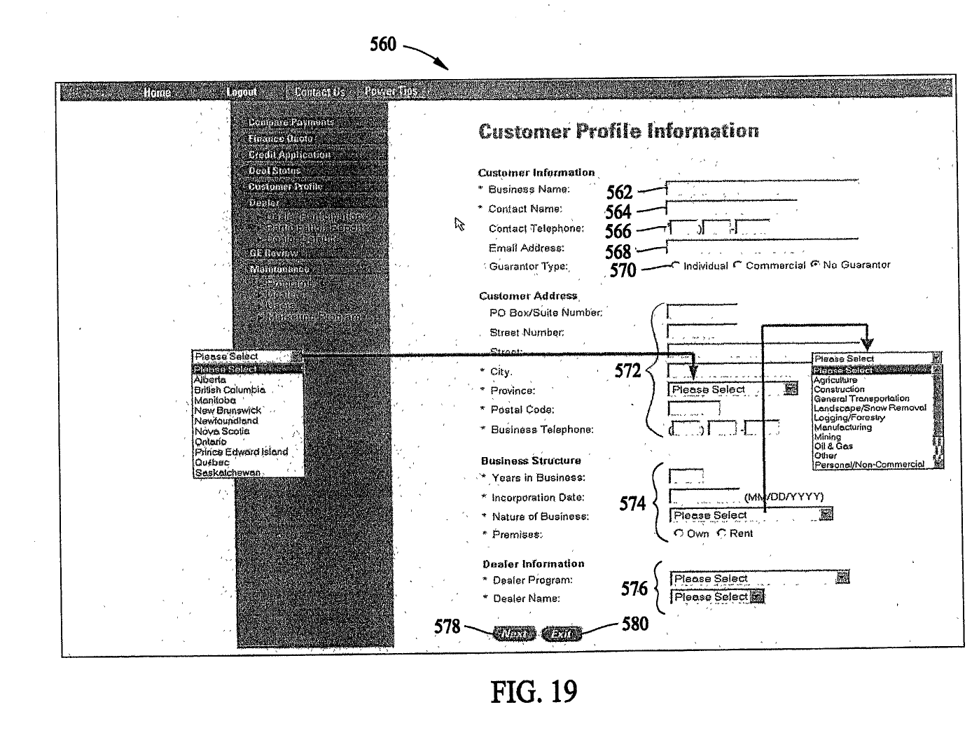

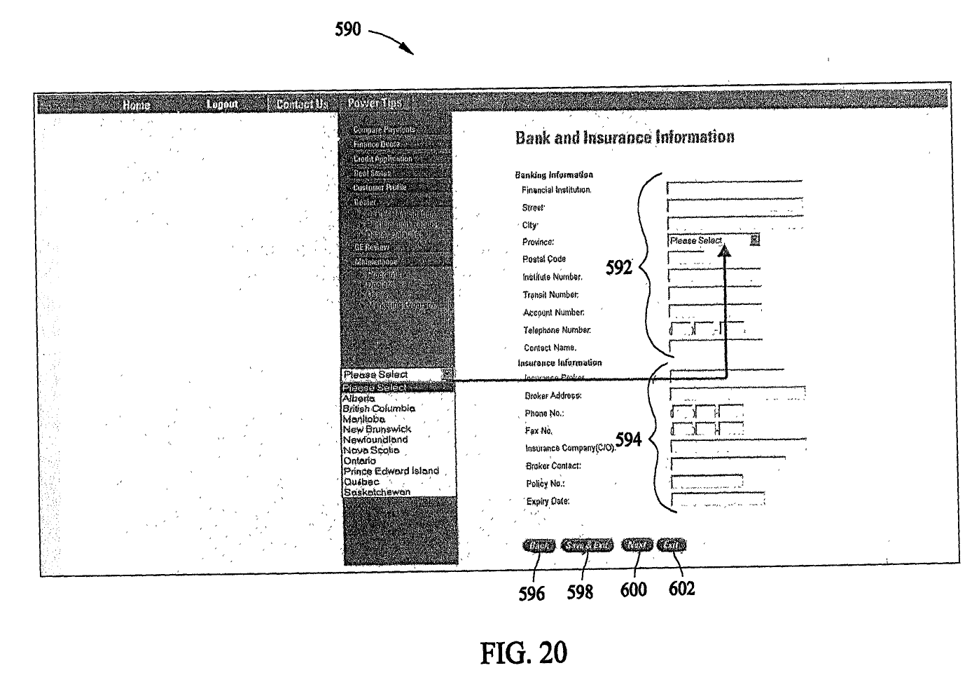

FIG. 18 is a user interface 530 displaying a Credit Application Main Page that is accessed by selecting either Credit application button 230 on the Navigation Bar 212 or selecting a Credit Application button on user interface 210 shown in FIG. 6. The user obtains a decision from system 10 regarding whether credit should be approved to an end-customer by supplying information to system 10 via user interface 530 and associated user interfaces. User interface 530 includes a Create New Customer Profile portion 532 that includes a New Commercial button 534 linking the user to a New Commercial customer page (shown in FIG. 19) and a New Individual button 536 that links the user to a New Individual customer page (shown in FIG. 20). Selection of either button 534 or button 536 enables system 10 to create a new customer profile. Alternatively, the user can request the system to search for an existing customer, i.e., customers previously entered into system 10. The search criteria include a customer number 538, a program 540, a dealer 542, a customer type 544, and a business name 546. The search criteria also include a first name 548, a last name 550, a city 552, and a province 554. Once the requested information is input, a search button 556 is selected and system 10 searches the appropriate database for a matching customer. If system 10 finds multiple matches to the search criteria, each matching entry will be displayed to the user with a prompt to select the correct customer profile. User interface 530 also includes an Exit button 558 that exits the user from the web site.

FIG. 19 is a user interface 560 displaying a New Commercial Customer Profile page that is accessed by selecting New Commercial button 534 on user interface 530 shown in FIG. 18. User interface 560 includes information blocks for receiving a business name 562, a contact name 564, a contact telephone number 566 and an email address 568. In addition, the user is prompted to select an appropriate guarantor 570, if a guarantor will be utilized for the transaction. If guarantor 570 is selected, system 10 transmits a Guarantor page (not shown) to the user for completion. The Guarantor page includes information requests directed to obtaining contact information of the guarantor. User interface 560 also includes a set of information blocks 572 pertaining to a Customer Address, a set of information blocks 574 pertaining to a Business Structure, and a set of information blocks 576 pertaining to Dealer Information. In addition, user interface 560 includes a Next button 578 to proceed to the next user interface and an Exit button 580 to exit the web site.

FIG. 20 is a user interface 590 displaying a Bank and Insurance Information page that is accessed by selecting Next button 578 on user interface 560 shown in FIG. 19. User interface 590 includes information blocks 592 for receiving banking information regarding the financial institution utilized by the user's company and information blocks 594 for receiving insurance information including the insurance broker and associated information. User interface 590 also includes a Back button 596 to transmit the previous user interface to the user, a Save and Exit button 598 to save the input information and leave the web site, a Next button 600 to transmit the next user interface to the user, and an Exit button 602 to exit the web site.

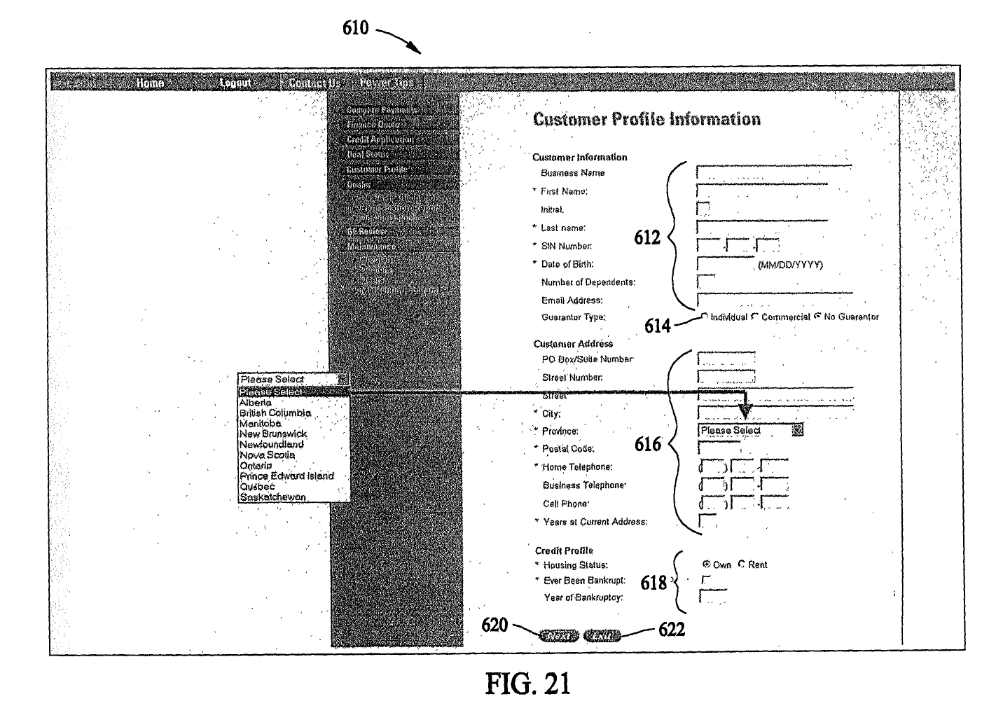

FIG. 21 is a user interface 610 displaying a New Individual Customer Profile page that is accessed by selecting New Individual button 536 on user interface 530 shown in FIG. 18. User interface 610 includes information blocks 612 for receiving customer information including guarantor type 614. The user is prompted to select an appropriate guarantor, if a guarantor will be utilized for the transaction. If guarantor 394 is selected, system 10 transmits a Guarantor page (not shown) to the user for completion. The Guarantor page includes information requests directed to obtaining contact information of the guarantor. In addition, user interface 610 includes information blocks 616 for receiving customer address information and information blocks 618 for receiving a credit profile of the customer. Accurate and complete information supplied in the information blocks highlighted by an asterisk increase the possibility of an instant decision and decrease turnaround time for the application. User interface 610 also includes a Next button 620 to transmit the next user interface to the user and an Exit button 622 to exit the web site.

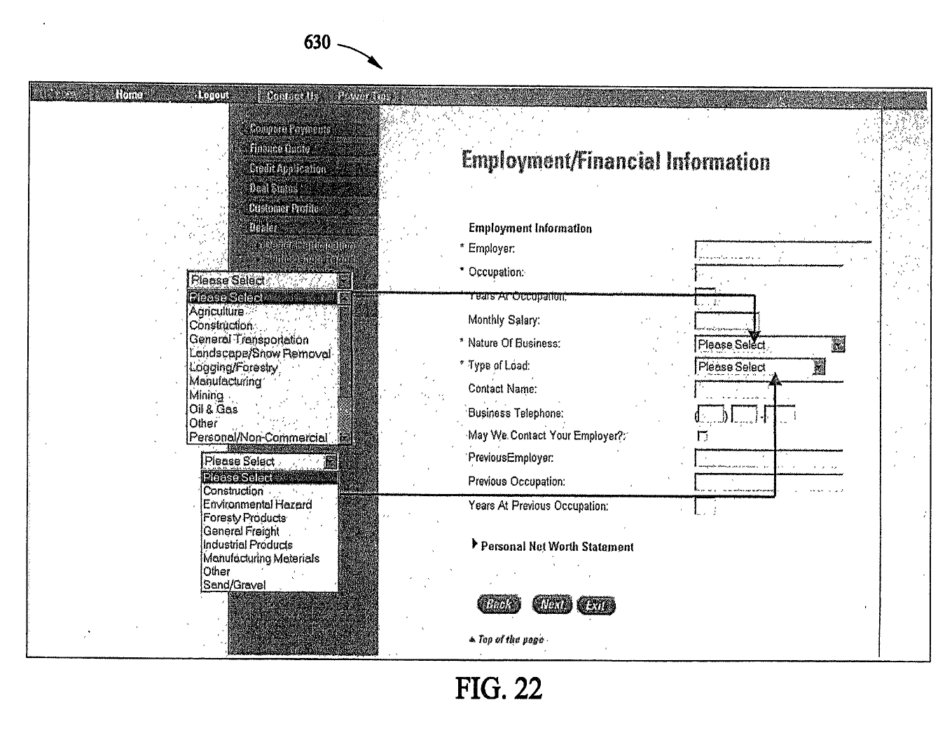

FIG. 22 is a user interface 630 displaying a first portion of an Employment/Financial Information page that is accessed by selecting Next button 620 on user interface 610 shown in FIG. 21. User interface 630 includes information blocks 632 for receiving employment information of the individual customer.

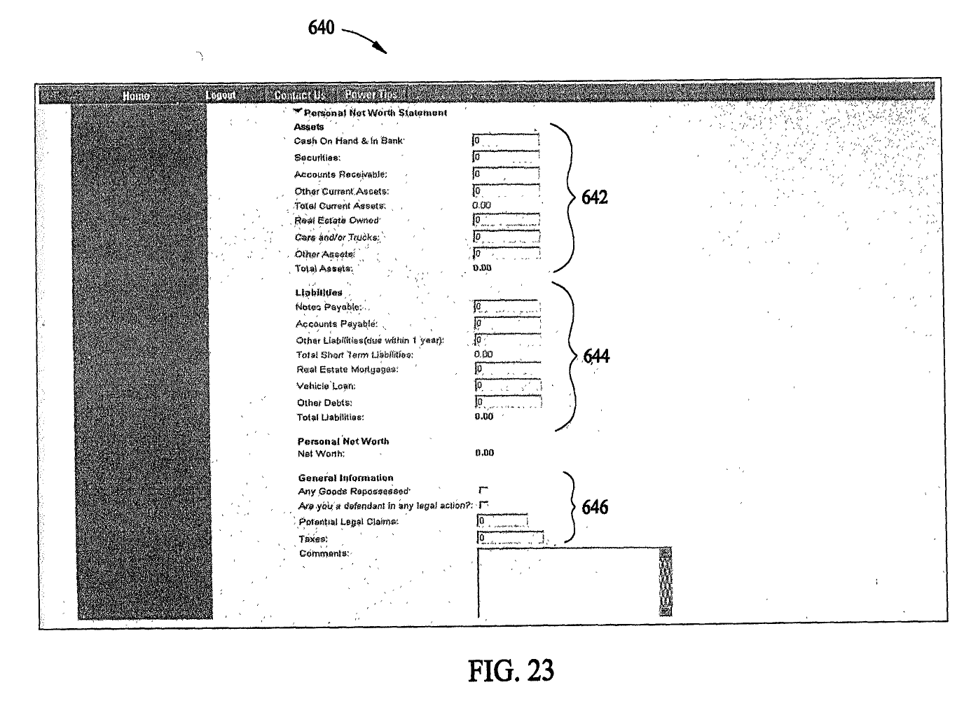

FIG. 23 is a user interface 640 displaying a second portion of an Employment/Financial Information page that is accessed by scrolling down user interface 630 shown in FIG. 22. User interface 640 includes information blocks for receiving information pertaining to the personal net worth of the individual. Such information blocks include an assets information block group 642, a liabilities information block group 644, and a general information block group 646. System 10 determines the customer's net worth based on the information input to user interface 640.

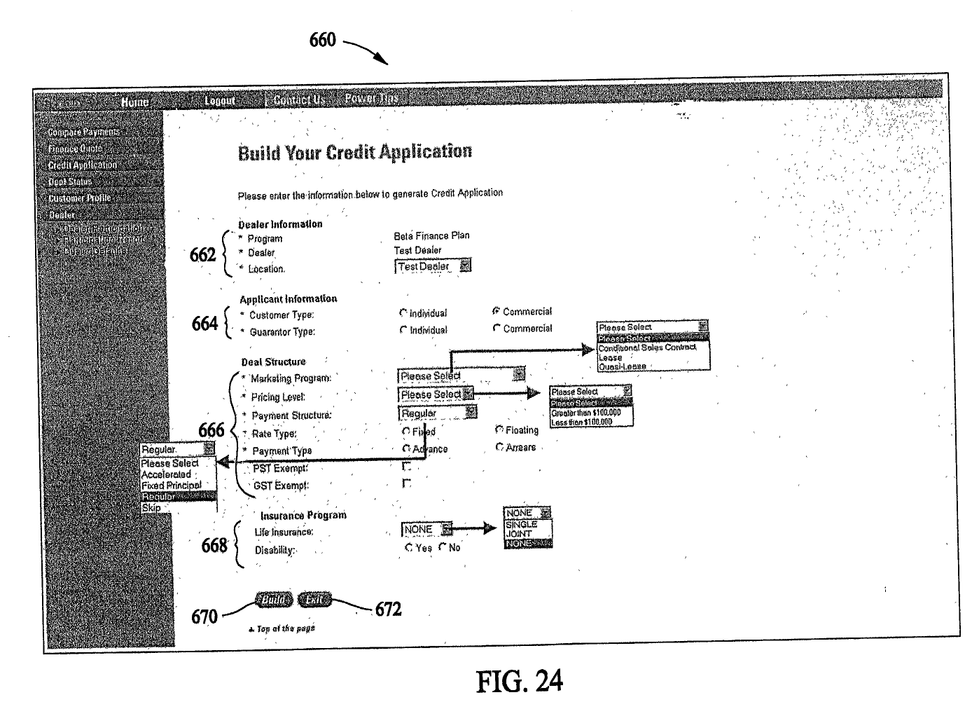

FIG. 24 is a user interface 660 displaying a Build Your Credit Application page that is accessible after a customer profile has been built or selected. User interface 660 includes a Dealer Information portion 662 that is populated based on the user's login ID and password. User interface 660 also includes an Applicant Information portion 664 that is populated based on information input to one of user interface 530 (shown in FIG. 18), user interface 560 (shown in FIG. 19), and user interface 610 (shown in FIG. 21). If information has not previously be input at one of user interfaces 530, 560, and 610, the user inputs the requested information in the associated information blocks. User interface 660 also includes a Deal Structure portion 666 that is utilized to determine the suitable deal structure for the customer, such as, marketing program, pricing level, payment structure, and rate type. User interface 660 further includes an Insurance Program portion 668 that includes information blocks pertaining to life insurance and disability insurance. User interface 440 also includes a Build button 670 to transmit the next user interface to the user, and an Exit button 672 to exit the web site.

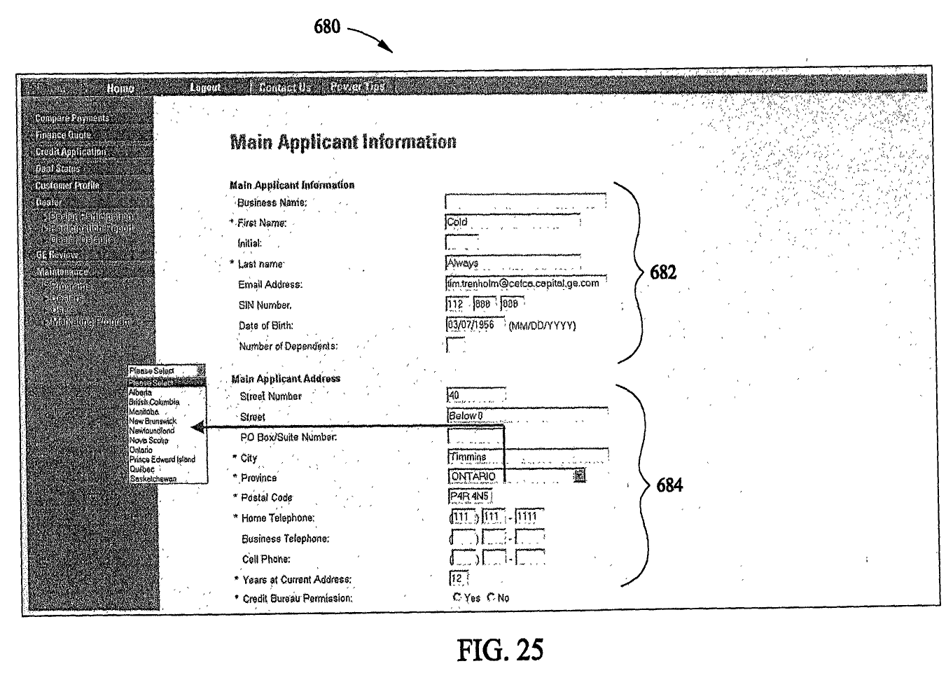

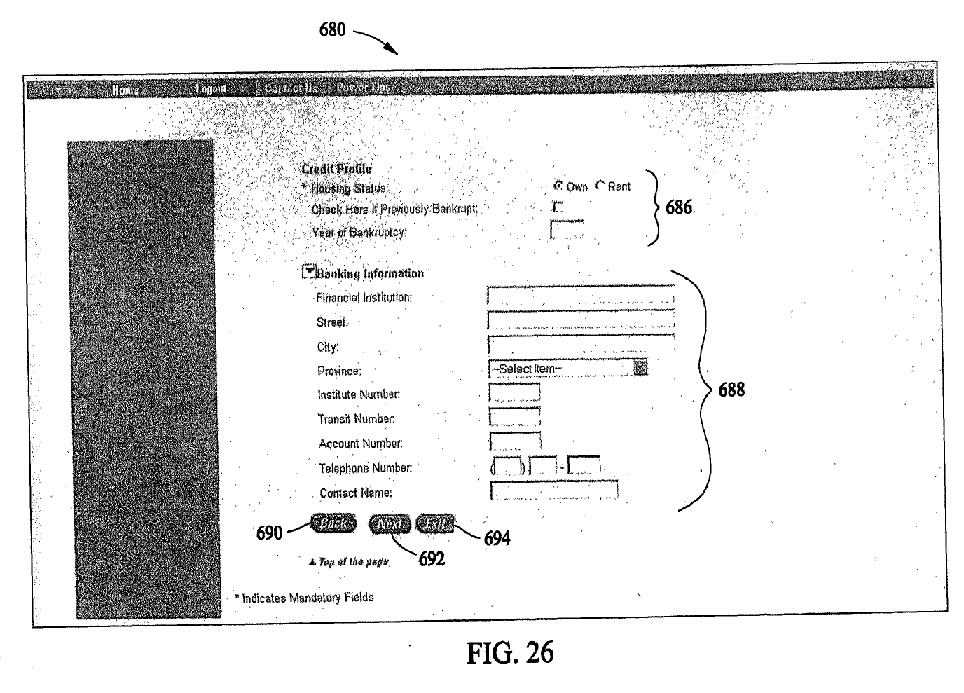

FIGS. 25 and 26 form a two part user interface 680 displaying a Main Applicant Information page that is accessed by selecting Build button 670 on user interface 660 shown in FIG. 24. User interface 680 shown in FIG. 25 includes a Main Applicant Information portion 682 with associated information blocks and a Main Applicant Address portion 684 with associated information blocks. User interface 680 shown in FIG. 26 includes a Credit Profile portion 686 and associated information blocks and a Banking Information portion 688 and associated information blocks. User interface 680 also includes a Back button 690 to transmit the previous user interface, a Next button 692 to transmit the next user interface, and an Exit button 694 to exit the user from the web site.

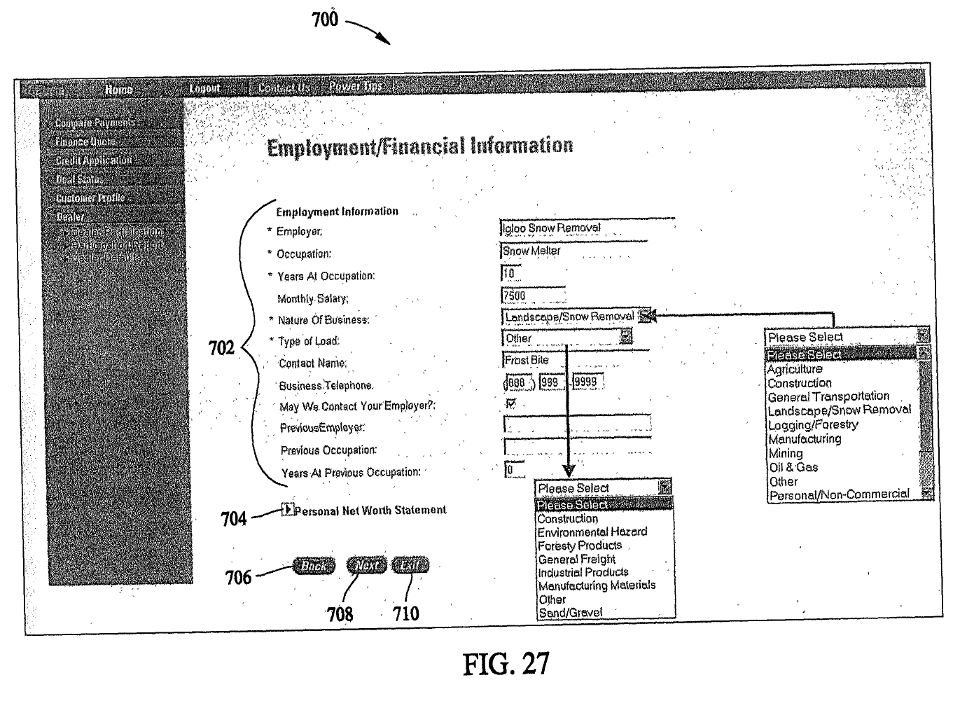

FIG. 27 is a user interface 700 displaying an Employment/Financial Information page that is accessed by selecting Next button 692 on user interface 680 shown in FIG. 26. User interface 700 includes information blocks 702 for receiving employment information of the individual customer. User interface 700 also includes a link 704 to a Personal Net Worth Statement of the customer. In addition, user interface 700 includes a Back button 706 to transmit the previous user interface to the user, a Next button 708 to transmit the next user to the user, and an Exit button 710 to exit the user from the web site.

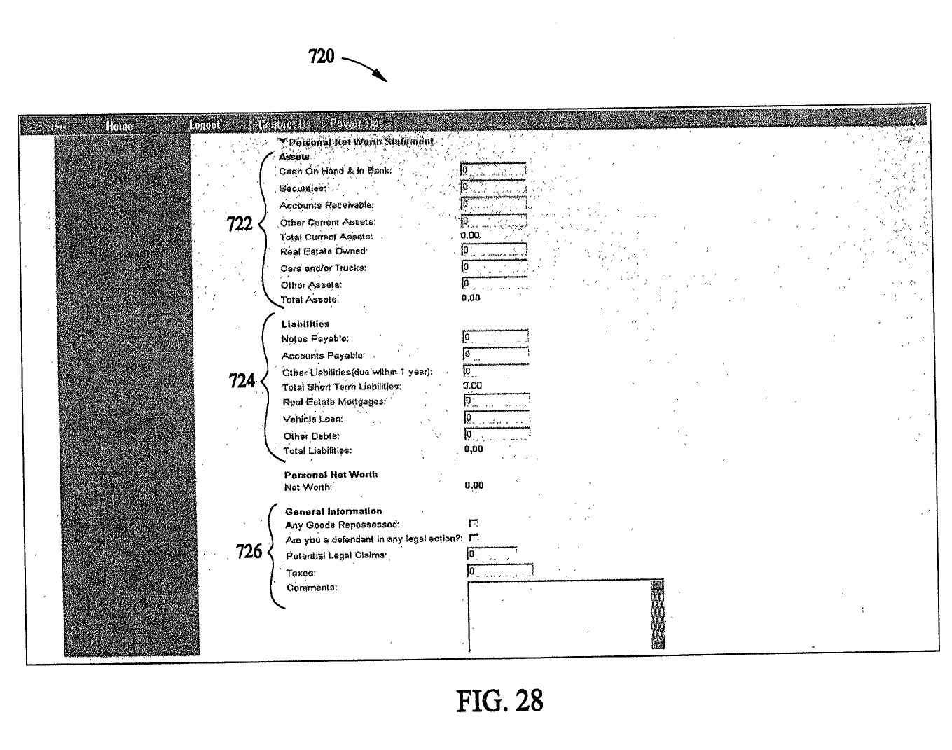

FIG. 28 is a user interface 720 displaying a Personal Net Worth Statement page for the customer. User Interface 720 includes information blocks for receiving assets information 722, liabilities information 724, and general information 726. System 10 determines the customer's net worth based on the information input to user interface 720.

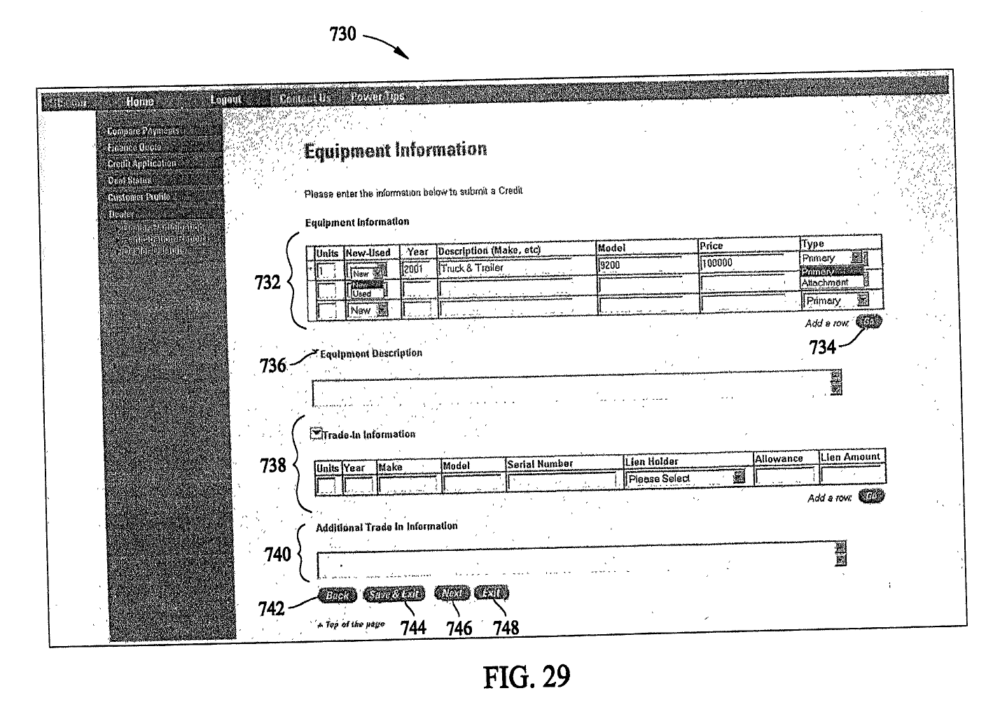

FIG. 29 is a user interface 730 displaying an Equipment Information page. User interface 730 includes an Equipment Information portion 732 that includes associated information blocks pertaining to number of units, new/used, year, description, model, price and type of equipment. If there are more than three pieces of equipment to be entered, the user selects the Go button 734 to add another row to the table. Additional information can be supplied by selecting Equipment Description link 736. User interface 730 also includes a Trade-in Information link 738 that, upon selection, supplies a Trade-in Information table (not shown) to the user for inputting information pertaining to trade-ins. User interface 730 also includes an Additional Trade-in Information block to supply additional trade-in information. User interface 730 further includes a Back button 742 to transmit the previous screen to the user, a Save and Exit button 744 to save the input information and exit the web site, a Next button 746 to transmit the next user interface, and an Exit button 748 to exit the web site.

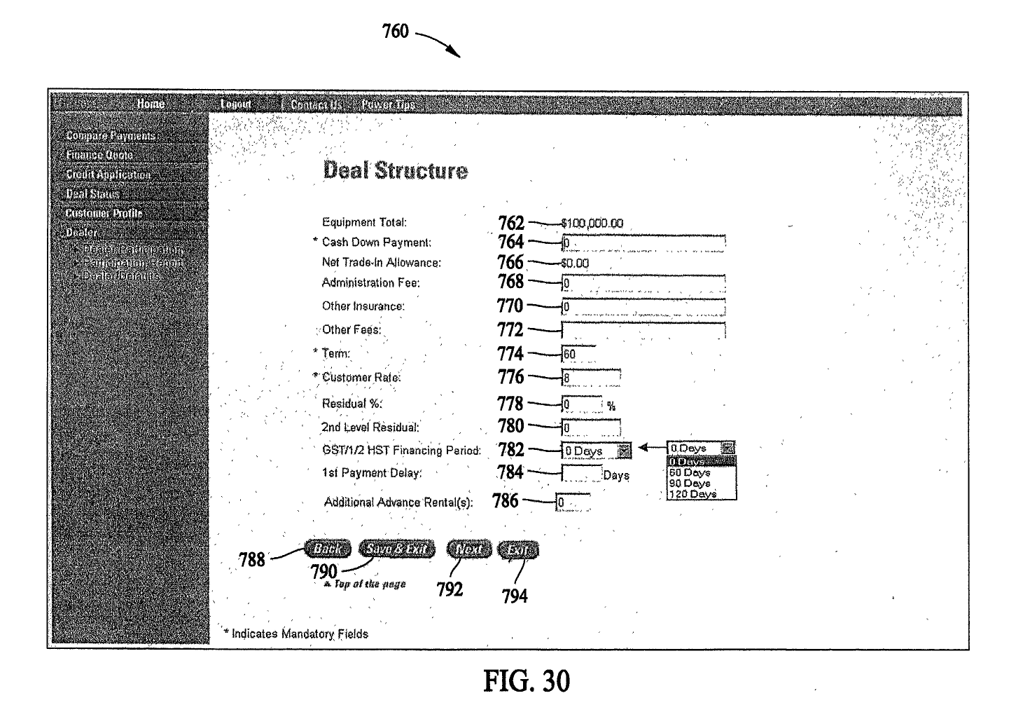

FIG. 30 is a user interface 760 displaying a Deal Structure page. User interface 760 includes an equipment total 762, a cash down payment information block 764, a Net Trade-in Allowance 766, an Administration Fee information block 768, an Other Insurance information block 770, an Other Fees information block 772, a Term information block 774, a Customer Rate information block 776, a Residual % information block 778, a 2nd level Residual information block 780, a GST/1/2 HST Financing Period information block 782, a 1st Payment Delay information block 784, and an Additional Advance Rental(s) information block 786. In addition, user interface 760 includes a Back button 788, a Save & Exit button 790, a Next button 792, and an Exit button 794.

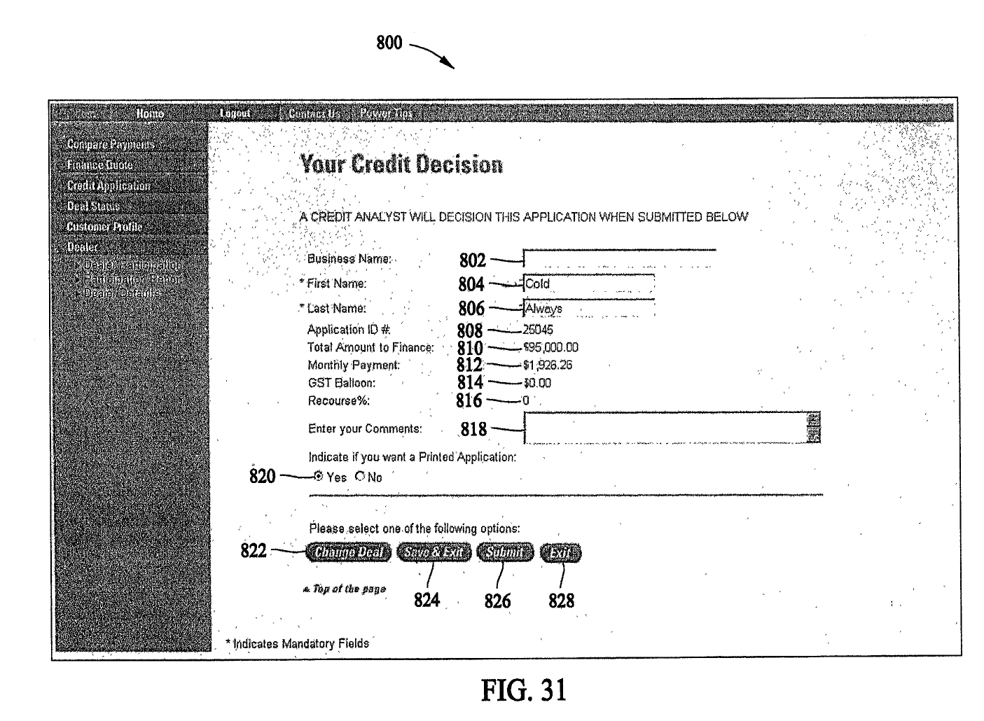

FIG. 31 is a user interface 800 displaying a Credit Submission page accessed once Next button 792 on user interface 760 shown in FIG. 30 is selected. User interface 800 includes information blocks pertaining to Business Name 802, First Name 804 and Last Name 806. In addition, user interface 800 populates a plurality of fields such as Application ID 808, Total Amount to Finance 810, Monthly Payment 812, GST Balloon 814, and Recourse % 816. User interface 800 also includes a comments box 818 for users to input comments to the credit analyst that will review the application. User interface 800 further includes a request to print documents 820, a Change Deal button 822, a Save & Exit button 824, a Submit button 826, and an Exit button 828. Selection of Change Deal button 822 allows the user to make changes to the application prior to submittal to the credit analyst. Selection of Save & Exit saves the information input into the system and exits the user from the web site. Selection of Submit button 826 submits the application to a credit analyst. Once the application is submitted to the credit analyst, no further changes can be made to the application, therefore, the entire application should be correct prior to submitting the application. Exit button 828 exits the user form the web site. Once the credit application is submitted, system 10 automatically generates a message that indicates the application has been accepted and changes can no longer be made to the application.

An analyst inputs the information and then selects Submit button 826. System 10 (shown in FIGS. 1 and 2) accesses a transaction system, such as described in FIG. 3, and generates a credit report for the indicated user. The credit report is transmitted to the Analyst's device where a final decision is made with respect to the application. A review module is provided to assist the analyst in the decision process. The credit analyst has the option of asking for additional information, pending the application, and declining the application. The analyst searches for an existing credit application by status, dealer, business name, customer name, application ID, and date range. To review an application from the results retrieved, the user selects a particular application from the list retrieved. System 10 displays a decision summary and a summary of the current credit decision for the application selected. System 10 provides the credit analyst with a set of options to view/modify the application information. The analyst may also modify the system decision and save the changes to the database. In one embodiment, the review module is only available to credit analysts.

Once a credit application has been approved, a documents module is utilized to generate the appropriate documents. The user searches for an approved credit application utilizing fields such as Business Name, Customer Name, Dealer Name, Application ID, Application Date, and Dealer Location. The user selects an application from the list of retrieved applications and system 10 displays information pertaining to Customer Summary, Co-Purchaser/Guarantor, Equipment, Trade-Ins, Transaction Summary, and Payment Summary. An exemplary listing of documents includes Lease Agreement, Loan, and Guarantor.

If a user, such as a dealer, desires to modify an existing Dealer Pending application, the dealer enters the search criteria to retrieve pending deals. Dealer Pending applications are applications the dealer chose to put on hold so the dealer could get additional information before submitting the deal. The deals with a status of “Dealer Pending” for that dealer or any salesperson reporting to that dealer are retrieved and displayed after the dealer submits the search criteria. The dealer may then modify Applicant Data, Address Information, Equipment, or Trade-Ins, and submit the deal to credit for approval. The dealer may also modify an existing application by modifying Reserve Type and Client Rate. Dealer Reserve is calculated from the financial institution rate and client rate on a Quote Screen (not shown). The dealer may enter a second level residual amount and may save the revised defaults and apply them to the current quote.

Retrieving an unsubmitted credit application can be performed by accessing Deal Status 232 from user interface 210 shown in FIG. 6. A credit application can be retrieved by searching at least one of Application ID, Business Name, First or Last Name, Date Range, Application Type/Status, and Sales Person. Once appropriate information is input into system 10, system 10 performs the requested search and retrieves all deals that match the search request. If more than one item is displayed by system 10, the user selects the correct application by selecting the respective link for that application. The user has the option to either submit the retrieved application unedited or edit the retrieved application. In addition, system 10 can be queried to provide a requested document to the user and the documents pertinent to the user can be searched by the user.

Dealers can also view the status of quotes, applications, and documented deals by sales person. The pertinent page includes hyperlinks on a particular quote, application or documented deal to view the details. System 10 also displays the dollar totals and counts by salesperson. The user has the option to appeal or modify a credit decision by selecting a hyperlink to a credit application, modifying it as desired, and resubmitting it for approval. The user is able to view the status of deals up to the time the deal is funded.

System 10 displays dealer profit in response to an on-line query. The displayed information includes first level profit (Customer Rate—Finance Institution Rate), second level profit (Residual), Insurance Premium, Extended Warranty, and Gap Protection. System 10 also maintains various types of dealership programs including the name and type, and dealer profile including dealer information, user ID, access level, dealer name, reporting relationships between dealers, dealer location, and other pertinent information. System 10 also maintains a list of equipment by dealership and the maximum price of the equipment.

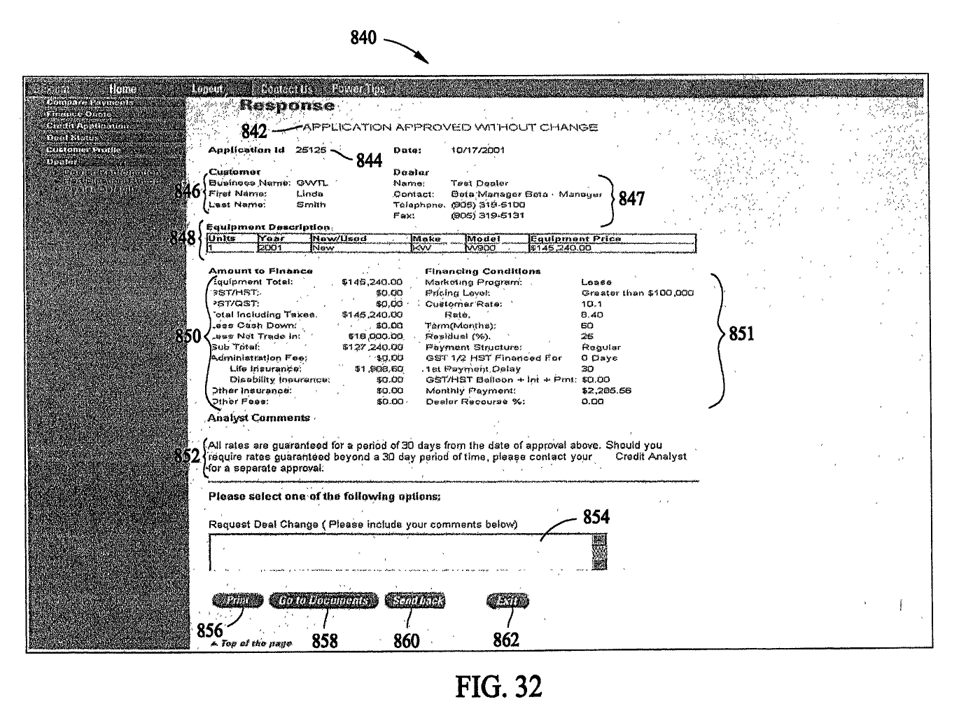

FIG. 32 is a user interface 840 displaying a Request Deal Change page accessed to edit, i.e., change, a credit application after the application has been submitted to system 10 and the credit analyst. User interface 840 includes an Application Status 842, an Application ID 844, a Customer information block portion 846, a Dealer information block portion 847, an Equipment information block portion 848, an Amount to Finance information block portion 850, a Financing Conditions information block portion 851, an Analyst Comments portion 852, and a Request Deal Change information block portion 854. A deal change is requested by entering comments in the Request Deal Change block 854 and providing the analyst with accurate details about the conditions that should be changed and the reasons for the proposed changes. Once the requested change is input, the user selects one of a Print button 856 to print the changed request, a Go to Documents button 858 to transmit the documents user interfaces to the user, a Send Back button 860 to send the changed deal to the credit analyst and system 10, and an Exit button 862 to exit the user from the web site.

If the credit analyst determines that additional information is needed prior to issuing a final decision on the credit application, the credit analyst will send to the user a request clearly indicating the additional information being requested. The user then has the opportunity to supply the requested information within a defined time period. Once the requested information has been submitted to the credit analyst, a credit decision will be forthcoming shortly.

New marketing programs can be added and displayed by system 10. The parameters for the marketing programs include a Dealership Program to which the marketing program applies, Dealer, Marketing Program name, Start Date, End Date, Financial Product, Term, Residual (% or amount) Second level residual, Customer Purchase Option, Make, Model, Year, Finance Institution Rate, Dealer Spread, Rate Type (Fixed/Floating) Cash Down %, Fees, and Dealer Reserve %. System 10 receives information pertaining to a buy rate regarding particular dealer/pricing groups. in one embodiment, each dealer belongs to a particular pricing group which determines the rate and reserve for the dealer.

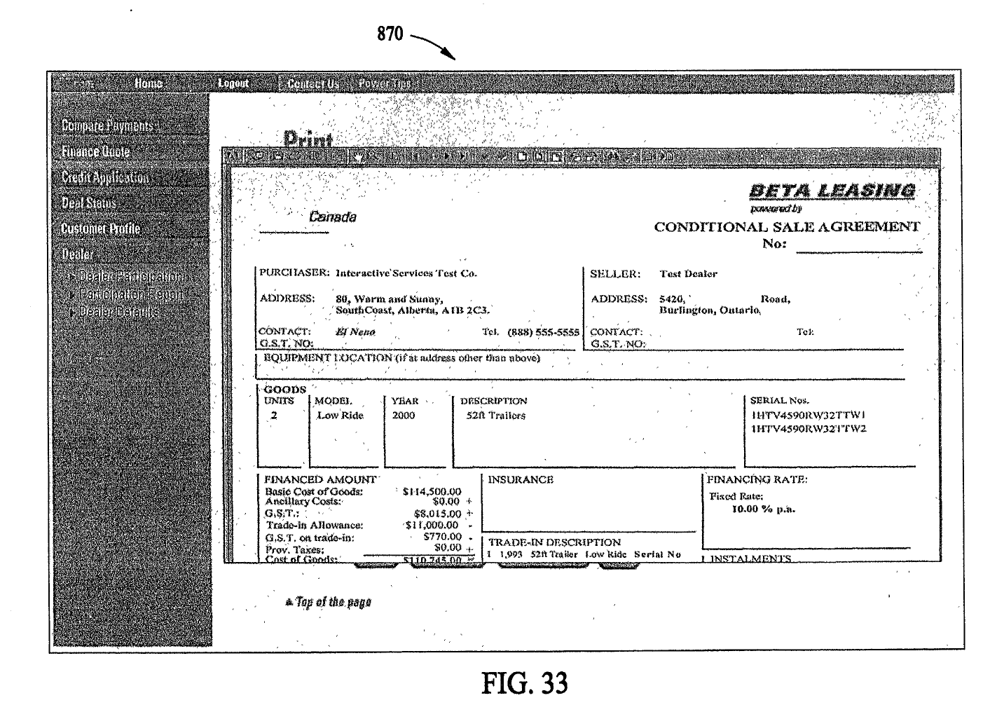

FIG. 33 is a user interface 870 displaying a printable version of the application available through system 10 once the credit application has been completed and approved. User interface 870 includes information pertaining to the terms and conditions of the accepted and approved credit application and system 10 generates reports based on the supplied information. System 10 also notifies the user that the reports have been generated and that the transaction will be funded within a predetermined period of time. System 10 requests the user to include a set of documents at the deal closing to avoid processing delays. Such documents include birth certificate and driver's license, Articles of Incorporation, and Insurance certificate. Additional documents that should be obtained for leases include copy of check for first payment or down payment, PST Exemption certificate if applicable, and an invoice from a dealer.

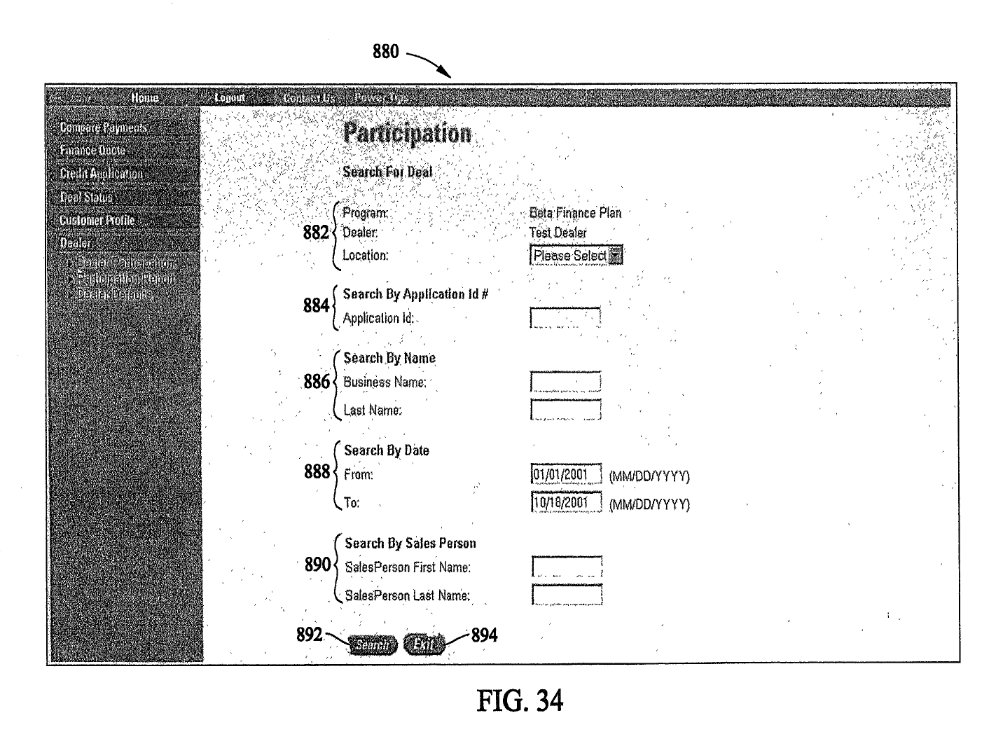

FIG. 34 is a user interface 880 displaying a Search for Dealer Participation page that is accessed by dealers attempting to search for one of their pending deals. User interface 880 includes a Search for Deal portion 882, a Search by Application ID # portion 884, a Search by Name portion 886, a Search by Date portion 888, and a Search by Sales Person portion 890. In addition, user interface 880 includes a Search button 892 to initiate the search procedure and an Exit button to exit the user from the web site. System 10 provides the user with a listing of any deals that match the search criteria entered by the user. The user can then select the appropriate deal for further processing thereof.

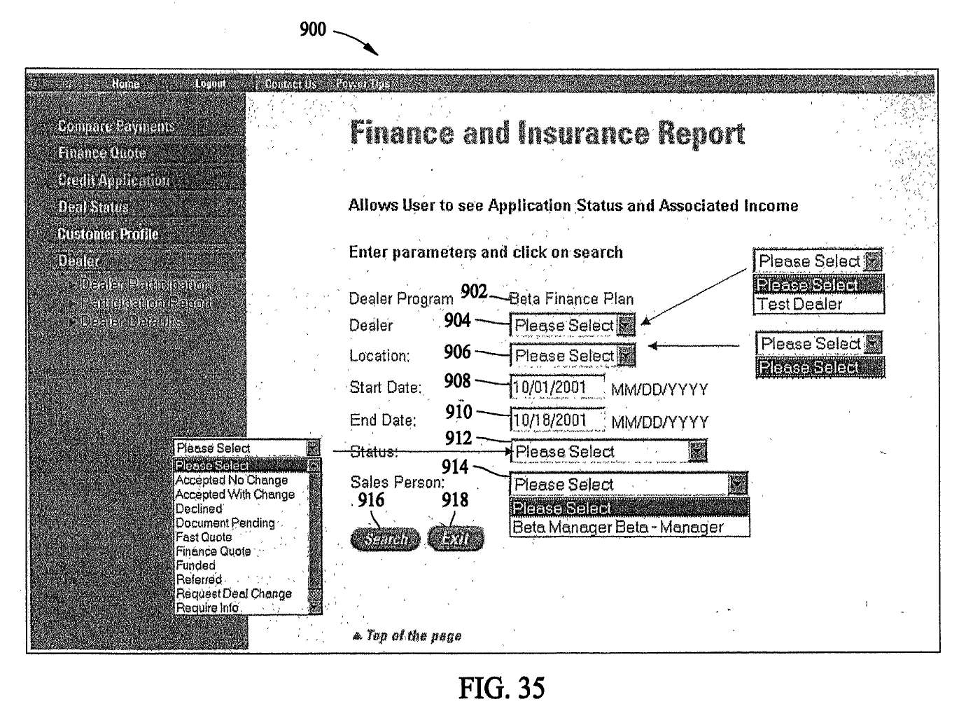

FIG. 35 is a user interface 900 displaying a Finance & Insurance Search Screen page that enables a user to see the application status and associated income. A user enters parameters such as Dealer Program 902, Dealer 904, Location 906, Start Date 908, End Date 910, Status 912, and Sales Person 914. Once the information has been entered, the user selects a Search button 916 that directs system 10 to search for applications that match the requested information. User interface 900 also includes an Exit button 918 that exits the user from the web site.

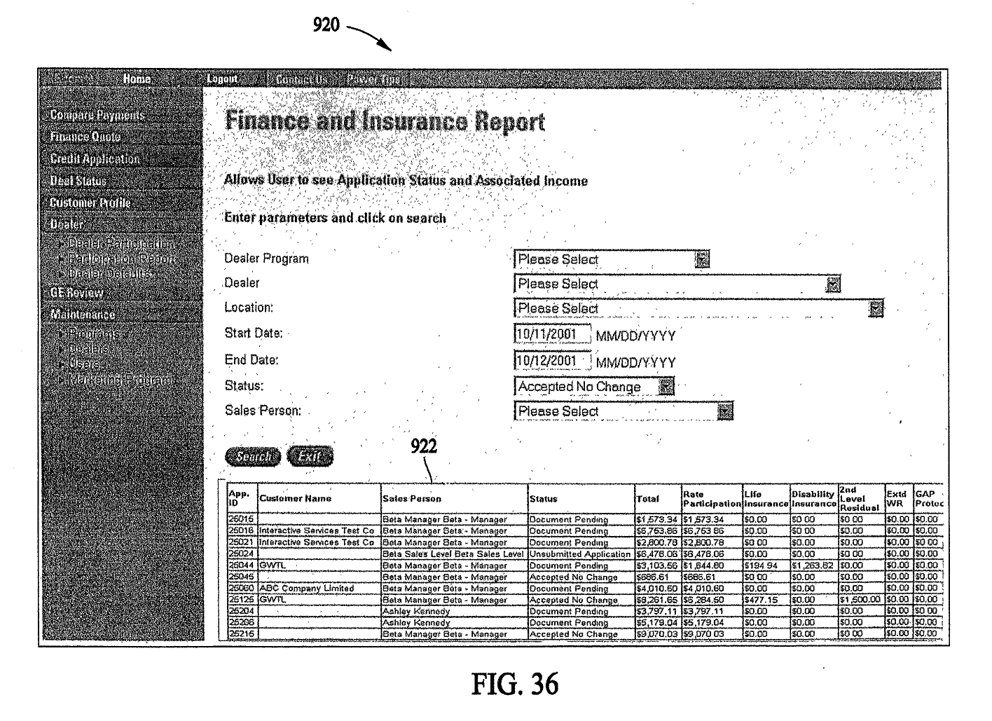

FIG. 36 is a user interface 920 displaying a Report Output page that displays a dealer report of applications and provides their status and value. User interface includes a table 922 that includes deal information pertaining to Application ID, Customer name, Sales Person, Status, Total, Rate Participation, Life Insurance, Disability Insurance, 2nd Level Residual, Extended Warranty, and GAP Protection. The dealer can view the information in a quick fashion and obtain a summary of the pertinent information pertaining to deals.

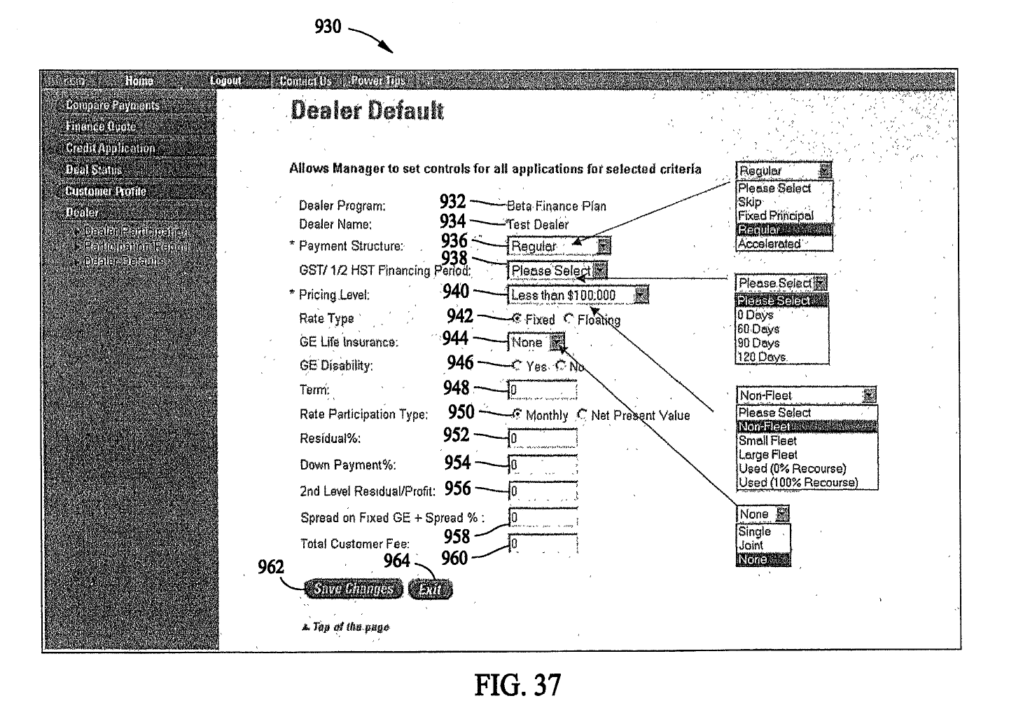

FIG. 37 is a user interface 930 displaying a Dealer Default Input page that is accessed by selecting a Dealer Defaults link 236 found in the Navigation bar of the user interfaces. User interface 930 allows a manager of a dealer to set controls for all applications for selected criteria. Factors that can be defaulted include dealer Program 932, Dealer Name 934, Payment Structure 936, GST/1/2/HST Financing Period 938, Pricing Level 940, Rate Type 942, Life Insurance 944, Disability 946, Term 948, Rate Participation Type 950, Residual % 952, Down Payment % 954, 2nd Level Residual/Profit 956, Spread on Fixed Spread % 958, and Total Customer Fee 960. In addition, user interface 930 includes a Save Changes button 962 to save any inputs made to user interface 930 and an Exit button to exit the user from the web site.

System 10 is easily updated by a finance institution since screens are provided for dealer profiles, marketing programs, pricing, equipment, and other information. System 10 provides reduced cycle times and to access easy to use interfaces that help to provide a rapid response. System 10 simplifies the data entry process by specifying default values for certain fields, and eliminates the need to advance through unnecessary prompts for simple credit applications. The user is able to view the documents online and print them. The web-based front-end is configured to be customized to the needs of a particular dealer without making any programming changes to the system. The customization provides flexibility to introduce new dealer programs quickly and easily. With access to the database, the dealer equipment lists and prices can be updated by the finance institution. New marketing programs can be introduced without additional programming effort by modifying a pre-defined set of parameters. The customer accesses the system from any computer utilizing the Internet and receives up-to-date status information regarding their deals and profits.

The above described system is adaptable to new markets, is easy to use, and provides proper documentation for a deal. Thus, manual work is decreased and cycle times are accordingly reduced. The system and method are dynamic, flexible, and easy to utilize. While the invention has been described in terms of various specific embodiments, those skilled in the art will recognize that the invention can be practiced with modification within the spirit and scope of the claims.

What is claimed is:

1. A method for processing asset finance applications using a web-enabled asset finance system including a web-based front end, a business logic middle tier, a credit scoring engine, and a relational database, said method comprising the steps of:
receiving information from a user device via the web-based front end;
utilizing the business logic middle tier to supply the received information to the relational database;
processing the received information to supply a finance quote; and
transmitting the processed information to the user device.

2. A method in accordance with claim 1 wherein the information received pertains to obtaining a finance quote, processing the information further comprises generating a payment schedule quote.

3. A method in accordance with claim 2 wherein transmitting the processed information further comprising transmitting the payment schedule quote to the user device.

4. A method in accordance with claim 1 wherein receiving information comprises receiving information pertaining to at least one of Application information, Value of Application, Financing Conditions, and Insurance.

5. A method in accordance with claim 4 wherein receiving Value of Application information comprises receiving information pertaining to at least one of Total Equipment Price, Cash Down, Allowance, Administration Fee, Other Fee, Lien Holder, and Monthly Maintenance Fee.

6. A method in accordance with claim 4 wherein receiving Financing Conditions information comprises receiving information pertaining to at least one of Marketing Program, Transaction Size, Term, Residual %, Rate, Subsidy, Rate Structure, Spread %, GST Financed For, and Payment Options.

7. A method in accordance with claim 1 wherein receiving information comprises receiving payment information pertaining to at least one of accelerated, regular, skip, and uneven payments.

8. A method in accordance with claim 1 wherein receiving information comprises:
receiving a user ID and a password; and
analyzing the user ID to determine a level of access the user has to the system.

9. A method in accordance with claim 1 wherein receiving information comprises receiving credit application information for at least one of Customer Information, Deal Structure, Equipment Information, and Deal Options.

10. A method in accordance with claim 9 wherein receiving Customer Information comprises receiving at least one of a Customer type and a Number of Guarantors.

11. A method in accordance with claim 9 wherein receiving Deal Structure comprises receiving at least one of a Deal size, Marketing Prog, Financial Product, GST Financial For, Pmt Structure, Rate Structure, Term, Residual %, and Customer Rate.

12. A method in accordance with claim 9 wherein receiving Equipment Information comprises receiving at least one of a Number of units, Trade-in, # of trade-in units, and Lien on trade-ins.

13. A method in accordance with claim 14 wherein receiving Deal Options comprises receiving at least one of a PST Exempt, Life Insurance, and Disability Insurance.

14. A method in accordance with claim 1 wherein receiving information comprises receiving information from a user via a customized web-based front end that displays information specific to a received user ID.

15. A method in accordance with claim 1 wherein processing the received information comprises interfacing at least one COM object with the credit scoring engine.

16. A method in accordance with claim 15 wherein transmitting the processed information comprises:
returning the processed information to the originating COM object; and
passing the returned information onto the user device which originated the request.

17. A method in accordance with claim 1 wherein processing the received information comprises:
performing credit scoring; and
making decisions regarding credit applications.

18. A method in accordance with claim 1 wherein processing the received information comprises implementing a series of business rules which reside in the business logic middle tier.

19. A method in accordance with claim 1 wherein transmitting the processed information comprises:
generating a document; and
storing the document on an appropriate file system.

20. A method in accordance with claim 1 wherein transmitting the processed information comprises:
returning a file pointer to the originating COM object; and
passing the file pointer on to the user device which originated the request.

21. A method in accordance with claim 1 further comprising supplying data from the asset finance system to a data repository system to obtain and track information on deal cycle times and other statistical information.

22. A method in accordance with claim 1 further comprising accepting deal changes from a user after an application has been approved if the changes are within certain predefined limits specific to that user.

23. A method in accordance with claim 22 further comprising:
flagging an application on which a deal change request has been received when the deal changes are outside of the predefined limits to that user; and
transmitting to the user a warning regarding a flagged application indicating that the deal changes may result in delays during funding.

24. A network-enabled asset finance system comprising:
a network-based front end;
a business logic middle tier linked to said front-end;
a credit scoring engine linked to said business logic middle tier; and
a relational database linked to said business logic middle tier, said business logic middle tier configured to:
receive information from a user device via said network-based front end;
supply the received information to said relational database;
receive processed information from said credit scoring engine; and
transmit the processed information to the user device.

25. A system in accordance with claim 24 wherein said business logic middle tier further configured to:
obtain a finance quote;
generate a payment schedule quote; and
transmit the payment schedule quote to the user device.

26. A system in accordance with claim 24 wherein said business logic middle tier further configured to:
receive a user ID and a password; and
analyze the user ID to determine the level of access the user has to the system.

27. A system in accordance with claim 24 wherein said business logic middle tier is linked to a user device by one of a local area network and a wide area network.

28. A system in accordance with claim 24 wherein said business logic middle tier is linked to a user device by the Internet.

29. A system in accordance with claim 24 wherein said business logic middle tier includes at least one COM object interfaced with said credit scoring engine.

30. A system in accordance with claim 29 wherein said business logic middle tier configured to:
accept the processed information from said credit scoring engine;
transfer the accepted information onto a user device which originated the request;
generate a document; and
store the document on an appropriate file system.

31. A system in accordance with claim 24 wherein said credit scoring engine configured to:
perform credit scoring; and
make decisions regarding credit applications.

32. A system in accordance with claim 24 wherein said business logic middle tier further configured to:
accept a file pointer to an originating COM object; and
pass the file pointer on to the user device which originated the request.

33. A method for processing asset finance applications on a website using an asset finance system including a web-based front end, a business logic middle tier, a credit scoring engine, and a relational database, said method comprising the steps of:
receiving information from a user device via the web-based front end;
accessing the business logic middle tier to supply the received information to the relational database;
processing the received information to supply at least one of a credit application decision and a finance quote; and
transmitting the processed information to the user device.

34. A method in accordance with claim 33 wherein processing the information further comprises generating a payment schedule quote.

35. A method in accordance with claim 33 wherein receiving information comprises receiving payment information pertaining to at least one of accelerated, regular, skip, and uneven payments.

36. A method in accordance with claim 33 wherein receiving information comprises:
receiving a user ID and a password; and
analyzing the user ID to determine a level of access the user has to the system and to determine the default settings for the interfaces to be shown to the user.

37. A method in accordance with claim 33 wherein receiving information comprises receiving credit application information.

38. A method in accordance with claim 33 wherein processing the received information comprises utilizing at least one COM object to access the credit scoring engine.

39. A method in accordance with claim 38 wherein transmitting the processed information comprises returning the processed information to the originating COM object.

40. A method in accordance with claim 33 wherein processing the received information comprises:
performing credit scoring; and
analyzing the scored credit application to determine if an instant credit decision can be made.

41. A method in accordance with claim 33 further comprising determining whether to accept deal changes from a user after an application has been approved.

42. A computer program embodied on a computer readable medium for analyzing a credit application input by a user on a web site to determine whether to accept the application, said program comprising a code segment that receives credit application and then:
reviews input information to determine whether all required information has been included;
scores the credit application to determine whether to accept the credit application;
determines whether an instant credit decision can be made; and
notifies the user of the credit application acceptance decision.

43. A computer program in accordance with claim 42 further comprising a code segment that stores the input information into an appropriate location of a database.

44. A computer program in accordance with claim 42 further comprising a code segment that populates subsequent information blocks with information input by the user.

45. A computer program in accordance with claim 42 further comprising:
a code segment that searches a database for previously input information on a credit application;
a code segment that retrieves matched information from the database;
a code segment that causes the retrieved information to be displayed on a user device;
a code segment that receives additional information input by the user into the retrieved credit application;
a code segment that interfaces with a credit scoring engine to obtain a credit score; and
a code segment that displays the obtained credit scoring information to the user at an appropriate device.

46. A network-enabled asset finance system comprising:
a network-based front end;
a business logic middle tier linked to said front-end;
a credit scoring engine linked to said business logic middle tier; and
a relational database linked to said business logic middle tier, said business logic middle tier configured to:
receive information from a user device via said network-based front end;
supply the received information to said relational database;
receive processed information from said credit scoring engine; and
generate documentation for the transaction.

47. A system in accordance with claim 46 wherein the system further configured to prompt a user to enter additional information.

48. A system in accordance with claim 46 wherein the system further configured to:
prompt a user to edit entered information;
compare the edited information to an originally approved transaction information stored in the database to determine changes to the information;
compare the changes to preset change parameters; and
if the changes are outside the parameters, provide a warning to the user that the edited information cannot be approved by the system.

49. A system in accordance with claim 47 wherein said system configured to generate documentation ready for signature by the user.
